(19) United States
(12) Patent Application Publication
(10) Pub. No.: US 2013/0038655 A1
(43) Pub. Date: Feb. 14, 2013

(54) PRINTING APPARATUS AND DENSITY CORRECTION METHOD

(71) Applicants: Masahiro Hayakawa, Kyoto-shi (JP); Satoru Kiyohara, Kyoto-shi (JP); Sachiko Takeuchi, Kyoto-shi (JP)

(72) Inventors: Masahiro Hayakawa, Kyoto-shi (JP); Satoru Kiyohara, Kyoto-shi (JP); Sachiko Takeuchi, Kyoto-shi (JP)

(21) Appl. No.: 13/521,232

(22) PCT Filed: Aug. 18, 2010
(86) PCT No.: PCT/JP10/63898

§ 371 Date: Jul. 10, 2012

(30) Foreign Application Priority Data
Mar. 29, 2010 (JP) JP2010-074217

(51) Int. Cl. B41J 29/38

(52) U.S. Cl. 347/14

(57) ABSTRACT

It is an object of the present invention to provide a technique which is capable of always achieving excellent print quality even in any use environment. In order to attain this object, a provisional print read data acquisition part displays provisional print read data which is acquired by reading a provisional printed matter, on a display part. When a user selects a position in the provisional printed matter through a provisional print read data display screen on which the provisional print read data is displayed, a selected position corresponding head specifying part specifies a head which performs printing on the selected position which is received and determines the head as a head to be corrected. A density correction part corrects the density of a printing area of which the head to be corrected is in charge.

### TECHNICAL FIELD

The present invention relates to an inkjet printing apparatus for ejecting ink droplets from a plurality of heads toward a printing medium to record something thereon.

### BACKGROUND ART

Conventionally, inkjet printing apparatuses (inkjet apparatuses) have been well known, each of which performs printing on printing media by causing an ejection head (hereinafter, referred to simply as a “head”) in which a plurality of outlets for ejecting fine droplets of ink therefrom are arranged, to scan the printing media.

For on-demand printing for a small number of copies and a small number of lots, the inkjet apparatuses are becoming a focus of attention as an alternative to offset printers. The inkjet apparatuses are, however, still inferior to the offset printers in print quality and need to improve the print quality. A technique for improving the quality of print images in the inkjet apparatuses is disclosed, for example, in Patent Document 1.

The inkjet method includes a so-called “scan method” and a so-called “one-pass method”. In the scan method, a head is moved to and fro several times in a direction (width direction) orthogonal to a printing direction, to thereby record (print) an image on a printing medium. On the other hand, in the one-pass method, a plurality of heads are arranged across an entire width direction of a printing medium and a lower portion of the head row passes over the printing medium only once, to complete recording of an image on the printing medium. The one-pass method has the advantage over the scan method in high speed printing, and therefore has particularly drawn attention in recent years.

### PRIOR-ART DOCUMENTS

### Patent Documents

[Patent Document 1] Japanese Patent Application Laid Open Gazette No. 2005-196646

### DISCLOSURE OF INVENTION

### Problems to be Solved by the Invention

One of the causes of degradation in print quality in one-pass inkjet apparatus is a variation in the ejection performance among the heads. When there is a variation in the amount of ejected ink among a plurality of heads, this causes inconsistencies in density (head level difference) in the width direction of a printed matter.

As a matter of course, an adjustment is made before shipping of the apparatuses so that the heads may have uniform ejection performance. In actual cases, however, since the ejection performances of the heads are changed in a subtle way depending on the use environment (e.g., the temperature environment) at the time when a printing operation is performed, it is difficult to avoid the occurrence of head level difference only with the adjustment before shipping of the apparatuses. In other words, in order to always ensure excellent print quality, it is necessary to check the conditions of the heads every time when a printing operation is performed, but conventionally there has been no way to easily check the conditions.

The present invention is intended to solve the above problem, and it is an object of the present invention to provide a technique which is capable of always achieving excellent print quality even in any use environment.

### Means for Solving the Problems

The present invention is intended for a printing apparatus which is an inkjet printing apparatus for performing printing by ejecting ink droplets from outlets of ejection heads toward a printing medium. According to a first aspect of the present invention, the printing apparatus comprises a plurality of the ejection heads arranged across an entire width direction of the printing medium, the width direction being a direction crossing a printing direction, a transfer part for relatively moving the printing medium and the plurality of ejection heads in the printing direction, a print control part for causing the ejection heads to eject ink droplets therefrom on the basis of print data while controlling the transfer part to relatively move the printing medium and the plurality of ejection heads in the printing direction, an image pickup part for picking up an image of a printed matter which is the printing medium after printing, and a target ejection head specifying part for specifying a target ejection head to be corrected among the plurality of ejection heads, and in the printing apparatus of the present invention, the target ejection head specifying part comprises a display control part for displaying picked-up image data of the printed matter acquired by the image pickup part on a display part, and a selected position corresponding head specifying part for receiving selection of a position in the printed matter from a user through a display screen displaying the picked-up image data, specifying an ejection head which performs printing on a selected position which is the received position in the printed matter, and determining the ejection head as the target ejection head.

According to a second aspect of the present invention, the printing apparatus of the first aspect further comprises a density correction part for correcting the density of a printing area of which the target ejection head is in charge.

According to a third aspect of the present invention, in the printing apparatus of the second aspect, the density correction part comprises a tone correction part for dividing the print data into partial areas corresponding to printing areas of which the plurality of ejection heads are in charge, respectively, and correcting tone values of pixels in each of the partial areas by using a coefficient which is individually set for the partial area, and a coefficient correction part for correcting a value of the coefficient which is set for a partial area corresponding to a printing area of which the target ejection head is in charge.

According to a fourth aspect of the present invention, in the printing apparatus of any one of the first to third aspects, the display part is a touch panel, and the selected position corresponding head specifying part receives a position in the display screen which the user touches, as the selected position.

According to a fifth aspect of the present invention, in the printing apparatus of any one of the first to third aspects, the selected position corresponding head specifying part displays split lines at positions in the display screen which correspond to boundaries between printing areas of which the plurality of ejection heads are in charge, respectively, in the printed matter which is displayed on the display screen.

The present invention is intended for a method of correcting density in an inkjet printing apparatus which performs printing by ejecting ink droplets from outlets of ejection heads toward a printing medium. According to a sixth aspect of the present invention, the method comprises the steps of a) performing provisional printing on the basis of print data by ejecting ink droplets from a plurality of the ejection heads on the basis of the print data while relatively moving the printing medium and the plurality of ejection heads arranged across an entire width direction of the printing medium in a printing direction, the width direction being a direction crossing the printing direction, b) picking up an image of a provisional printed matter which is generated in the step a), c) displaying picked-up image data of the provisional printed matter on a display part, d) receiving selection of a position in the provisional printed matter from a user through a display screen displaying the picked-up image data, e) specifying an ejection head which performs printing on a selected position which is the position in the provisional printed matter, which is received in the step d), and 0 correcting the density of a printing area of which a target ejection head is in charge, the target ejection head being the ejection head specified in the step e).

### Effects of the Invention

According to the first aspect of the present invention, the printing apparatus displays the picked-up image data of the printed matter on the display screen, specifies the ejection head which performs printing on the position selected by the user through the display screen, and determines the ejection head as an ejection head to be corrected. In other words, when the user selects a problematic position (for example, a position having a head level difference) in the printed matter through the display screen on which the picked-up image data of the printed matter is displayed, the ejection head which performs printing on the problematic position is immediately specified as the ejection head to be corrected. Therefore, since it is possible to easily and appropriately specify the ejection head to be corrected when a real printing is actually performed, it is possible to always achieve excellent print quality even in any use environment.

According to the second aspect of the present invention, the density of the printing area of which the target ejection head is in charge can be corrected. In other words, when the user selects the position where the head level difference occurs in the printed matter, the ejection head which causes the head level difference can be specified and the density of the printing area of which the ejection head is in charge can be corrected. Therefore, it is possible to easily and reliably resolve the head level difference.

According to the fourth aspect of the present invention, since the display part is a touch panel, it is possible for the user to easily and accurately select the position.

According to the fifth aspect of the present invention, since the split lines are displayed at the positions in the display screen which correspond to boundaries between printing areas of which the plurality of ejection heads are in charge, respectively, in the printed matter which is displayed on the display screen, even when there is a head level difference in the printed matter, the user can prevent himself from missing the head level difference.

According to the sixth aspect of the present invention, in the method, the picked-up image data of the printed matter is displayed on the display screen, the ejection head which performs printing on the position selected by the user through the display screen is specified, and the ejection head is determined as an ejection head to be corrected. Then, the density of the printing area of which the target ejection head is in charge is corrected. In other words, when the user selects a problematic position (for example, a position having a head level difference) in the printed matter through the display screen on which the picked-up image data of the printed matter is displayed, the ejection head which performs printing on the problematic position is immediately specified as the ejection head to be corrected and the density of the printing area of which the ejection head is in charge is corrected. Therefore, since it is possible to easily and appropriately specify the ejection head to be corrected when a real printing is actually performed, it is possible to always achieve excellent print quality even in any use environment. Further, since the density of the printing area of which the ejection head to be corrected is in charge is corrected, it is possible to easily and reliably resolve the head level difference.

These and other objects, features, aspects and advantages of the present invention will become more apparent from the following detailed description of the present invention when taken in conjunction with the accompanying drawings.

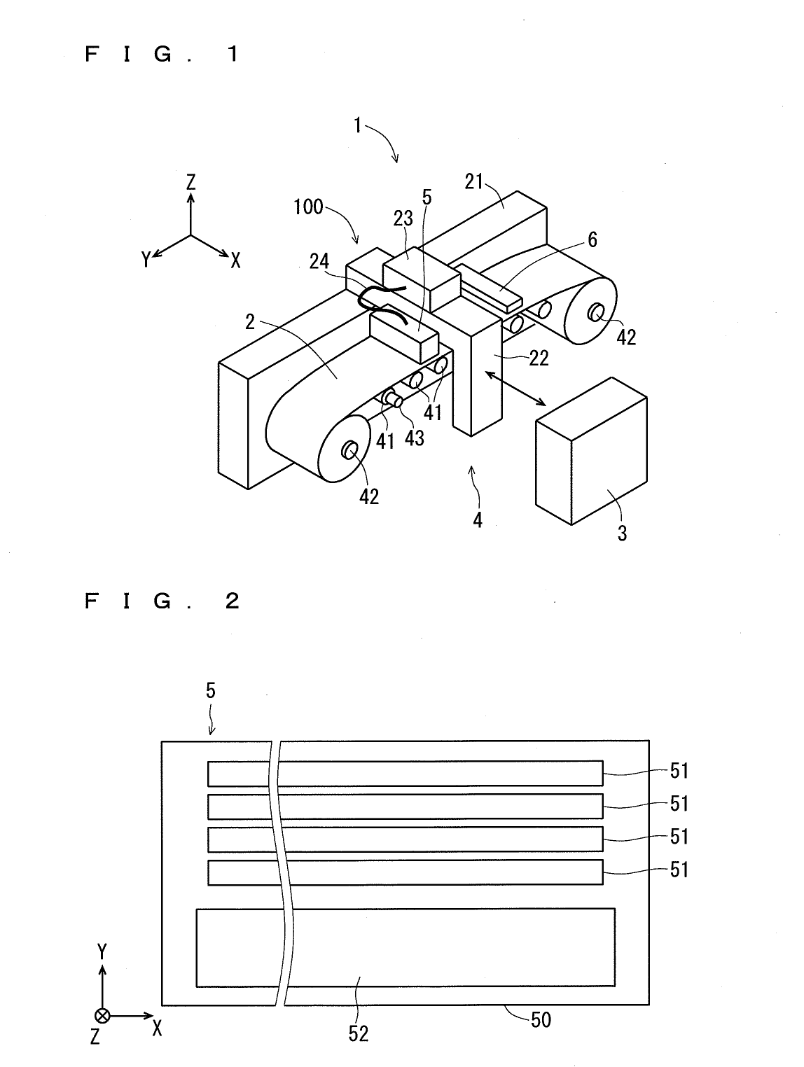

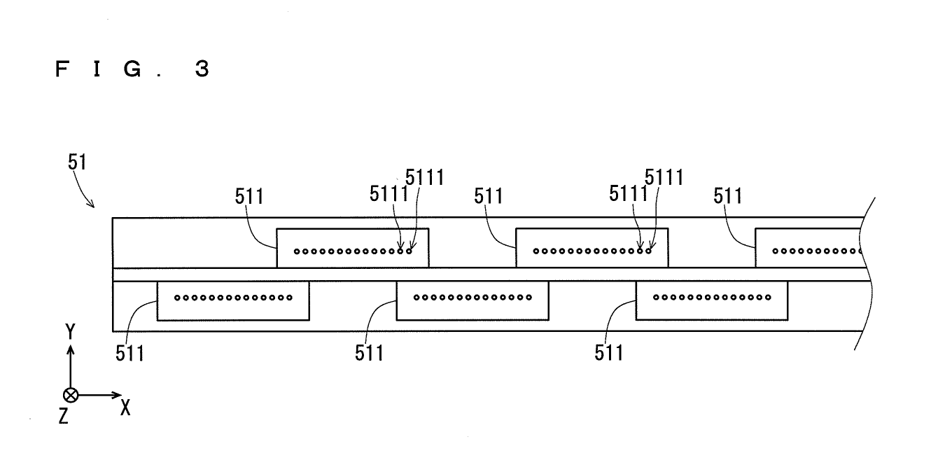

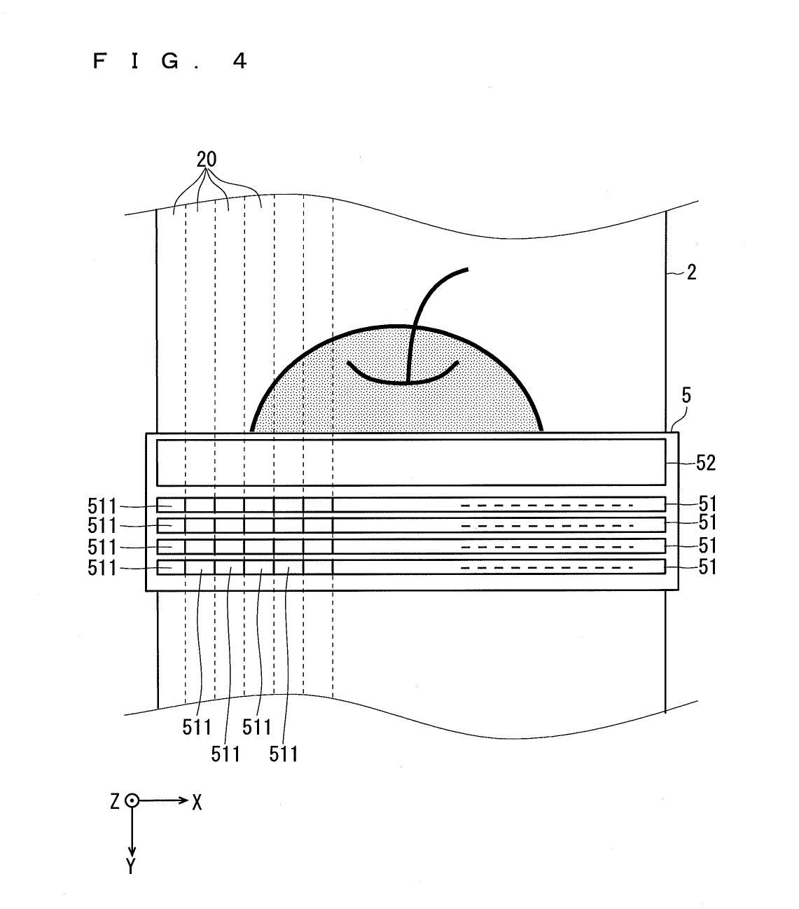

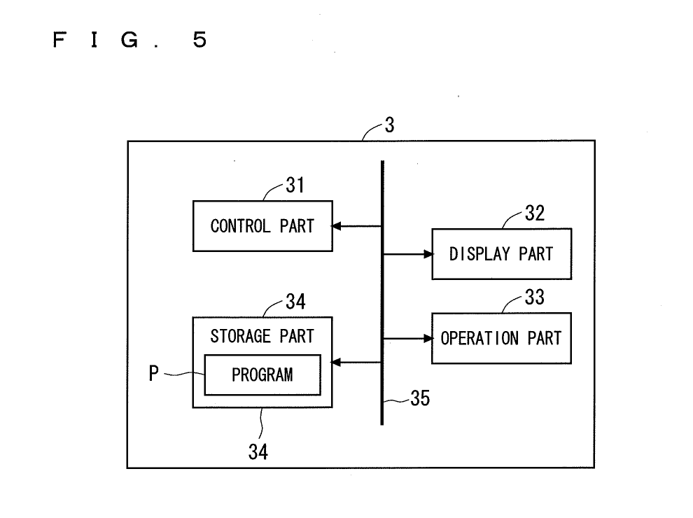

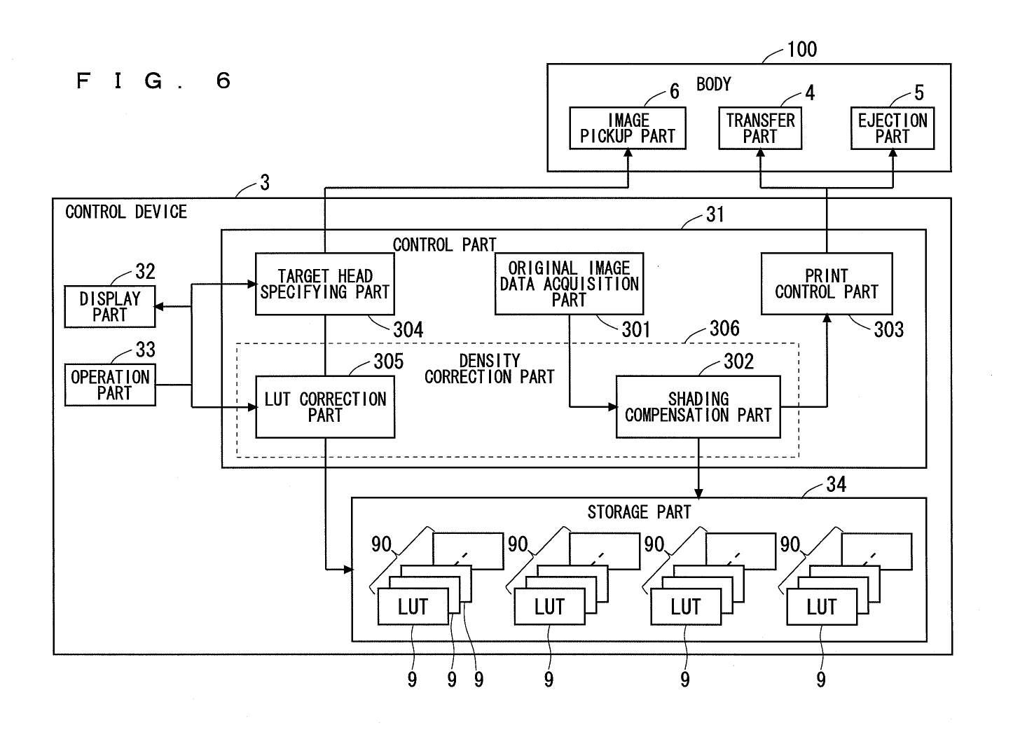

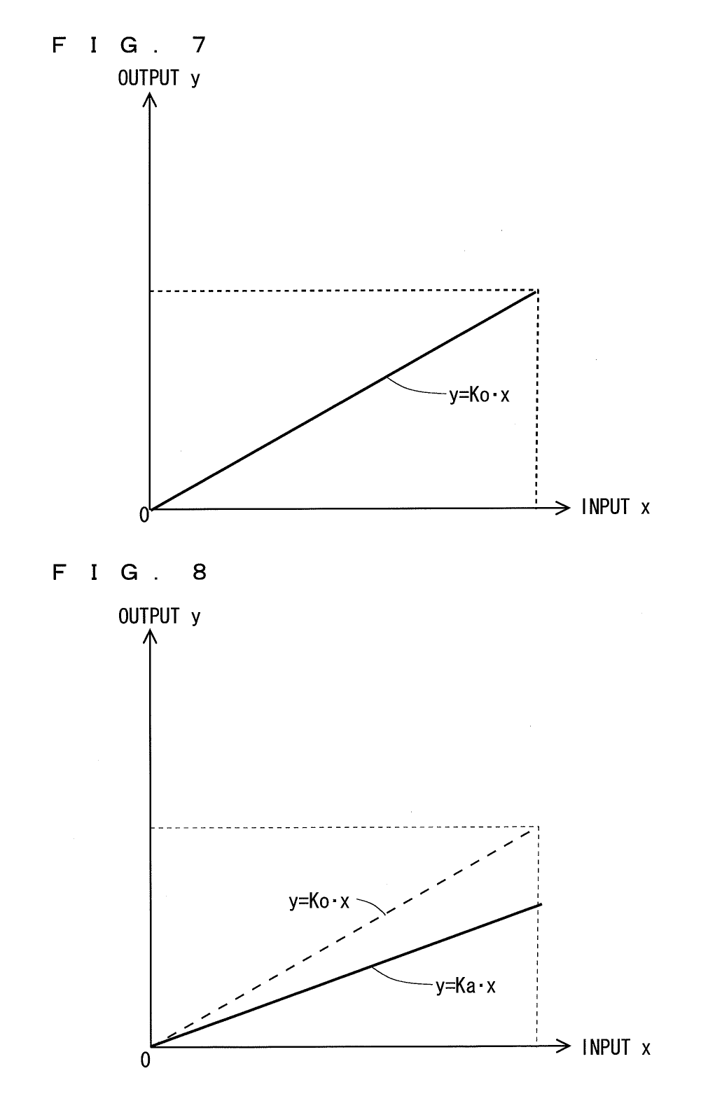

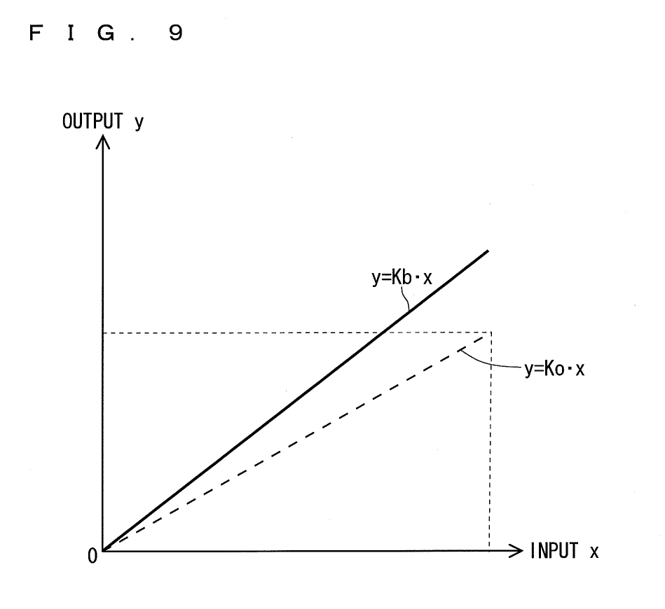

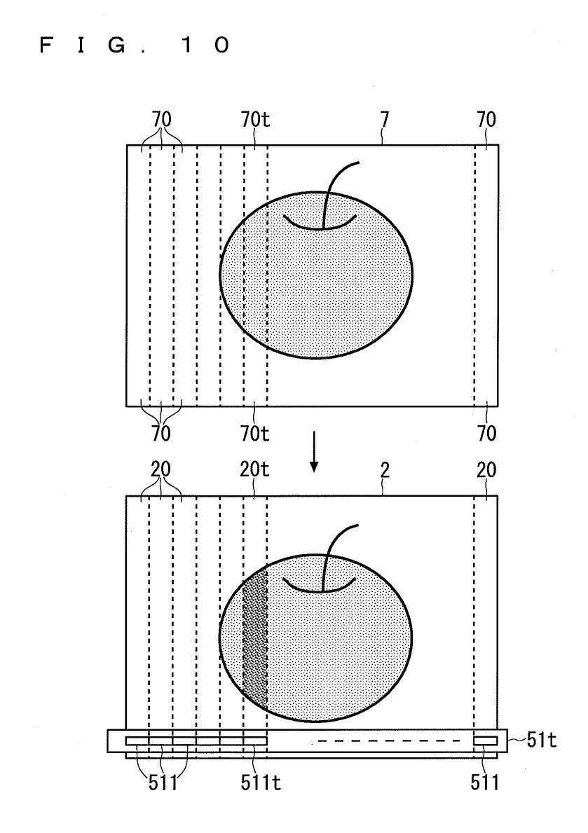

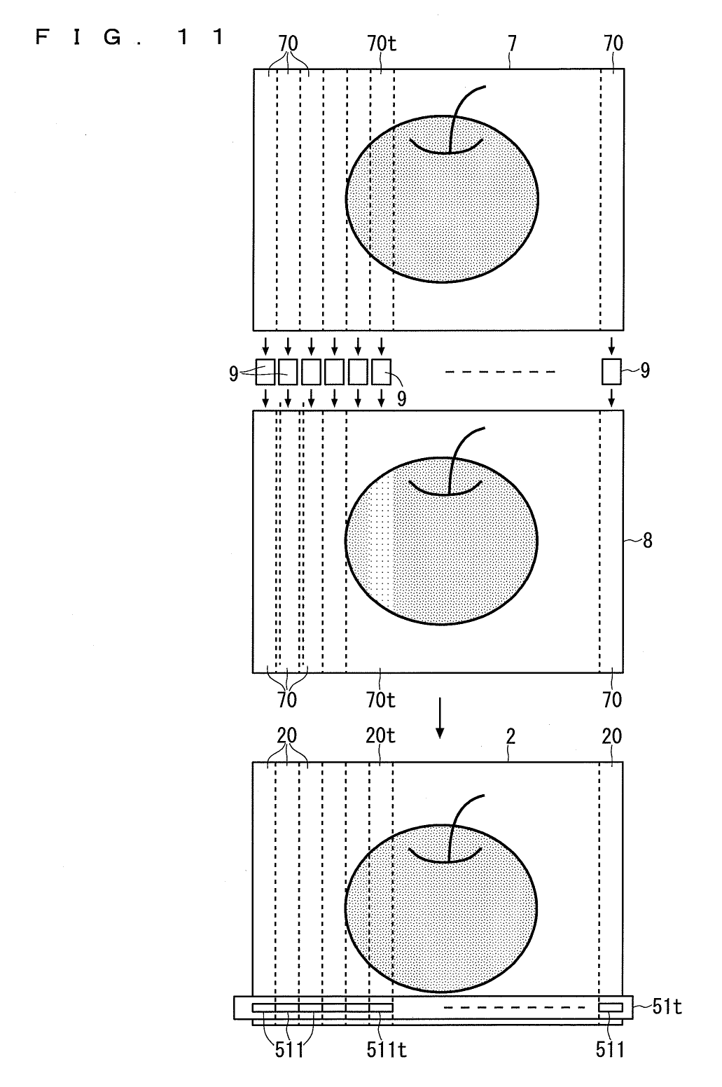

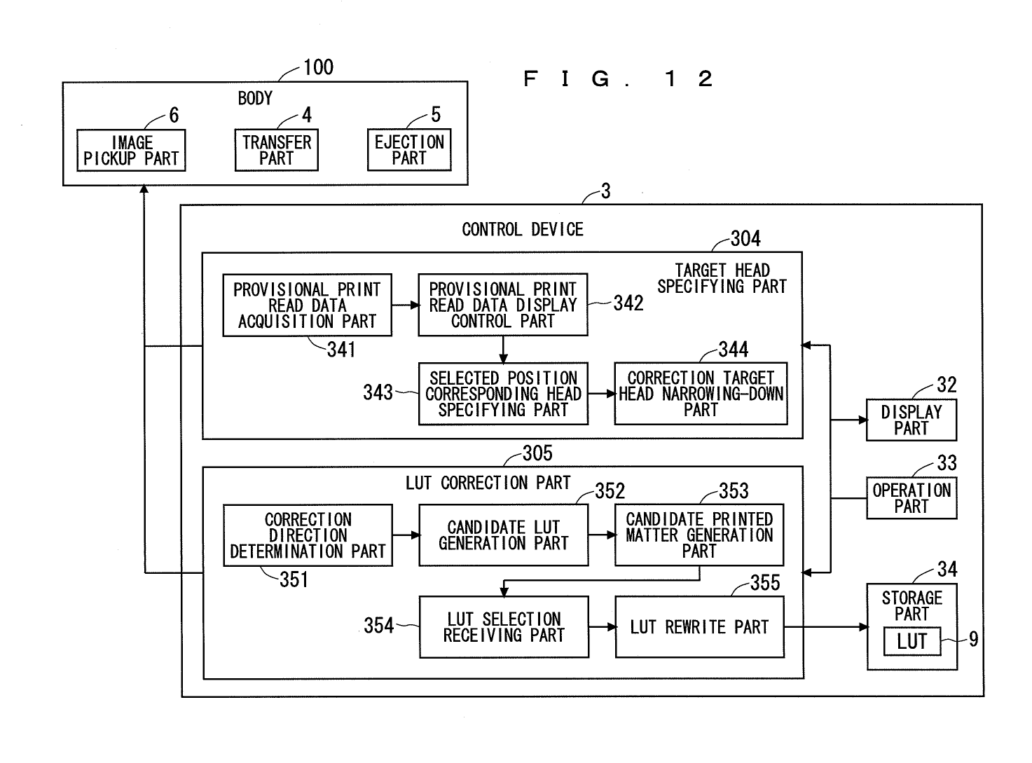

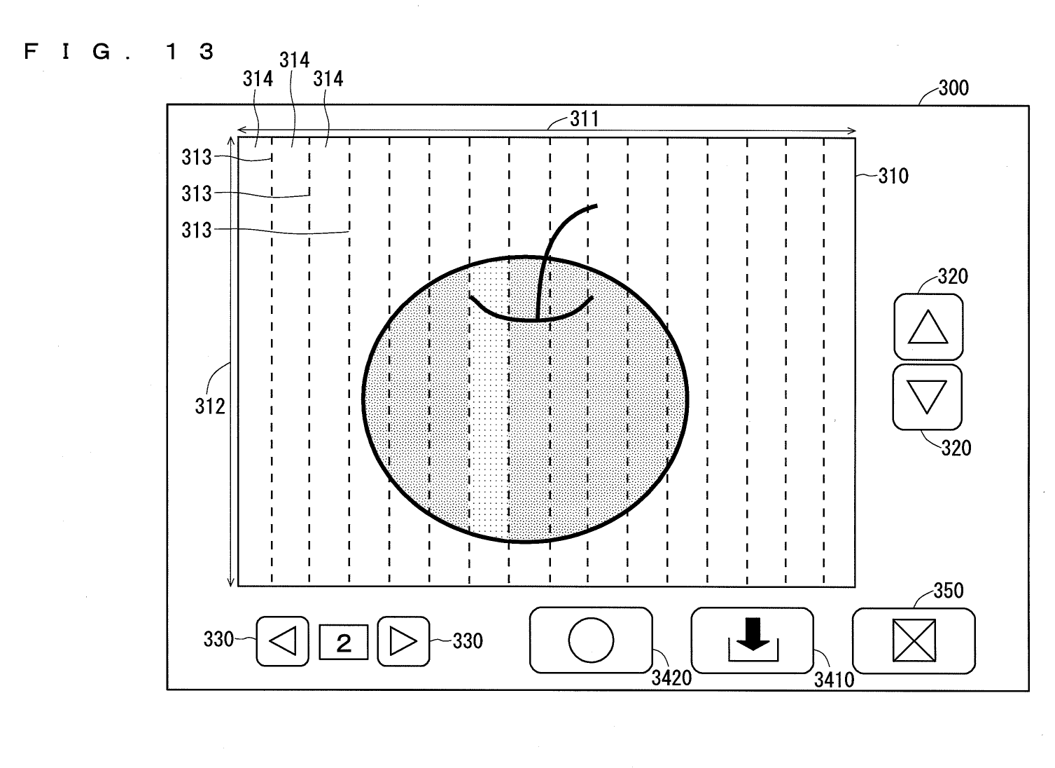

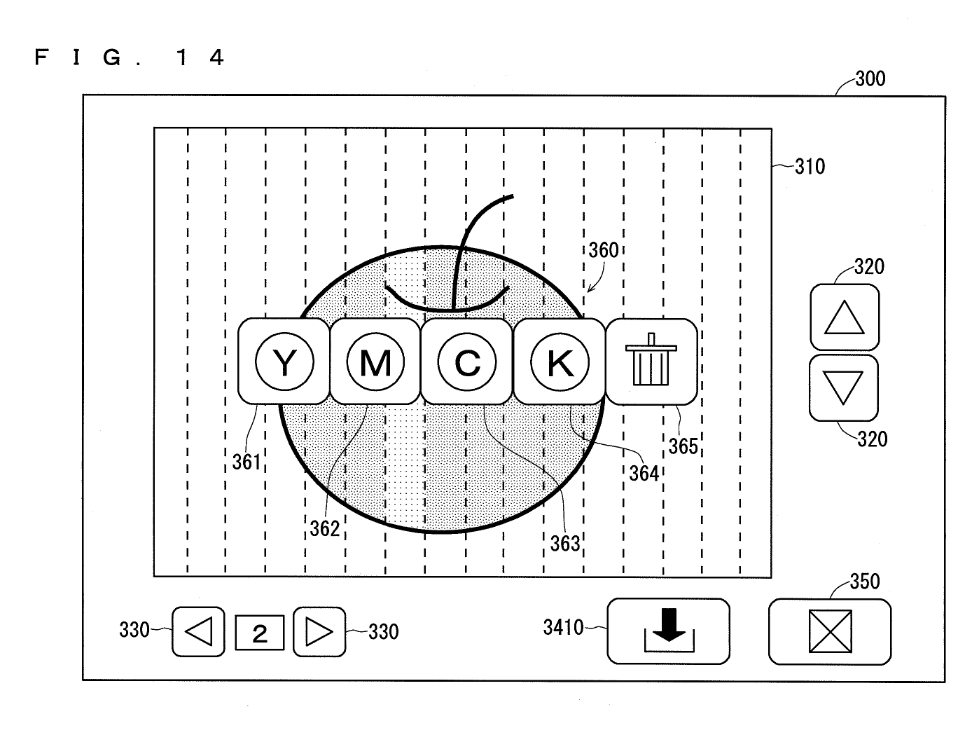

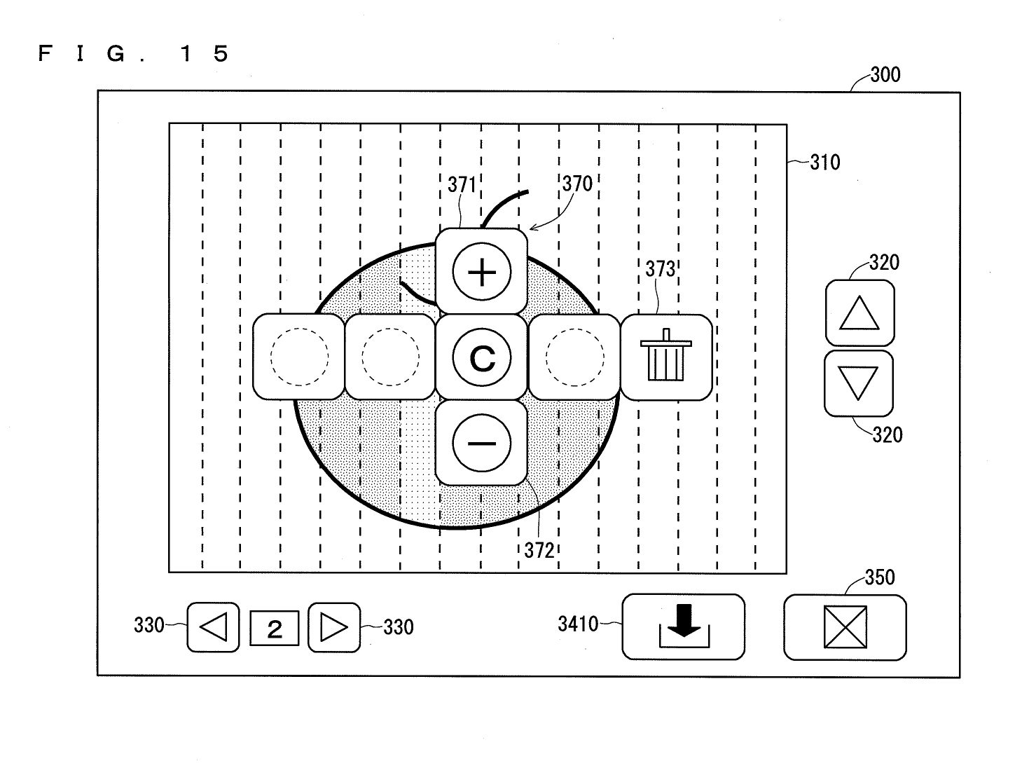

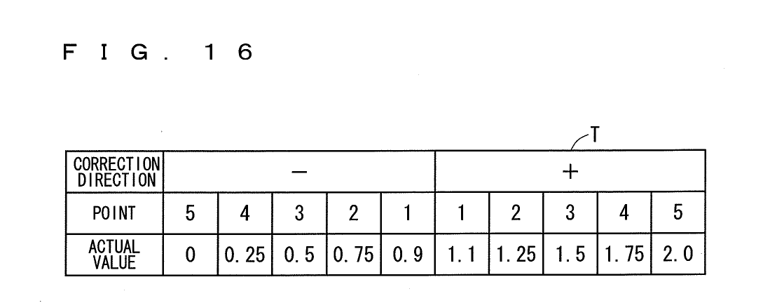

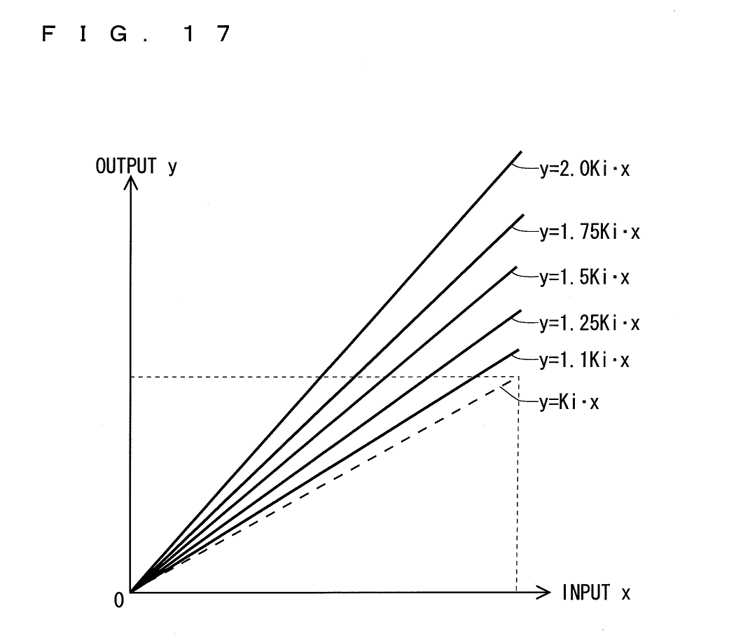

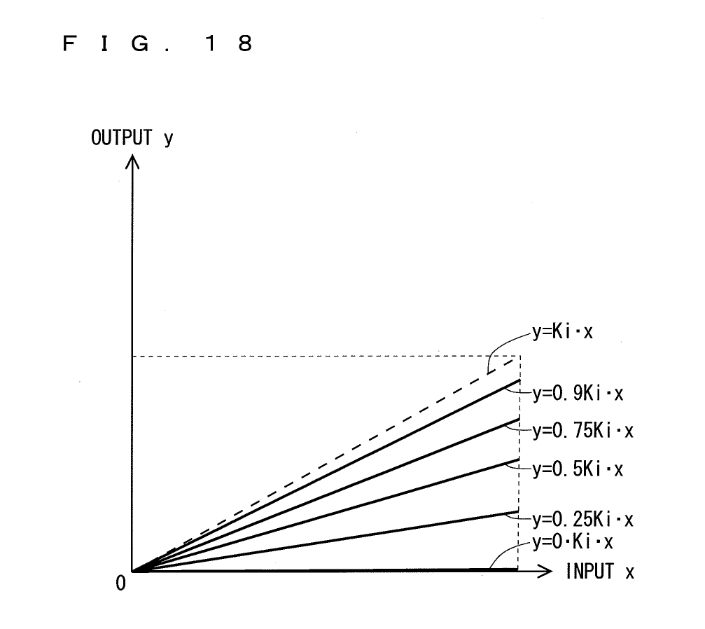

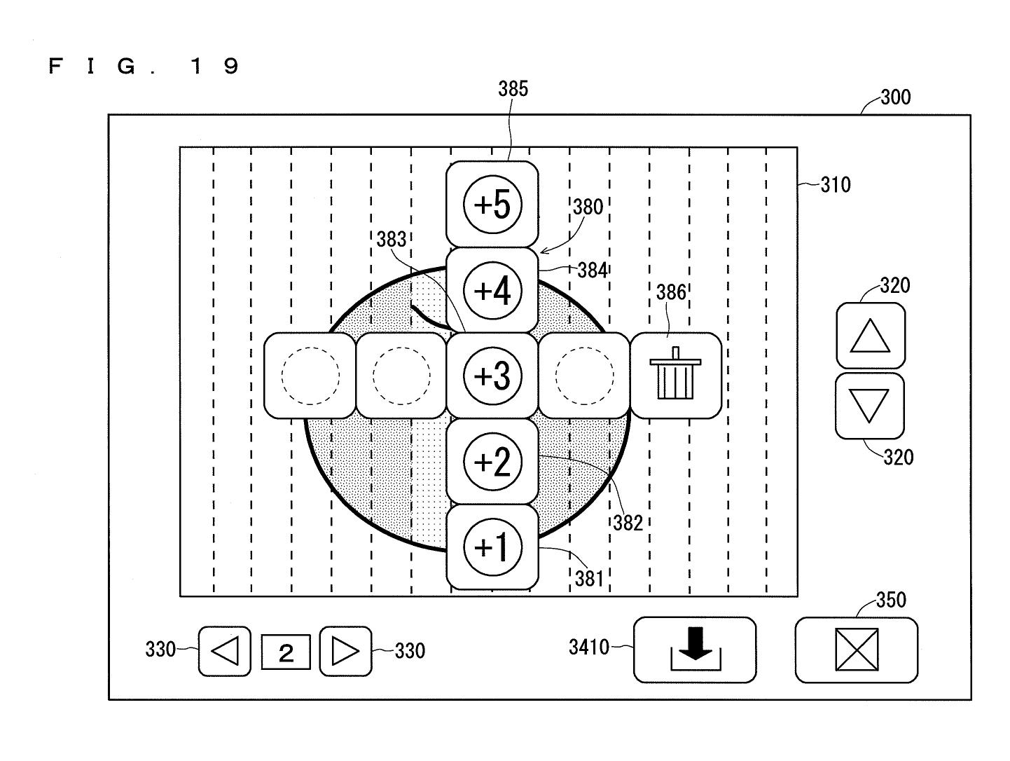

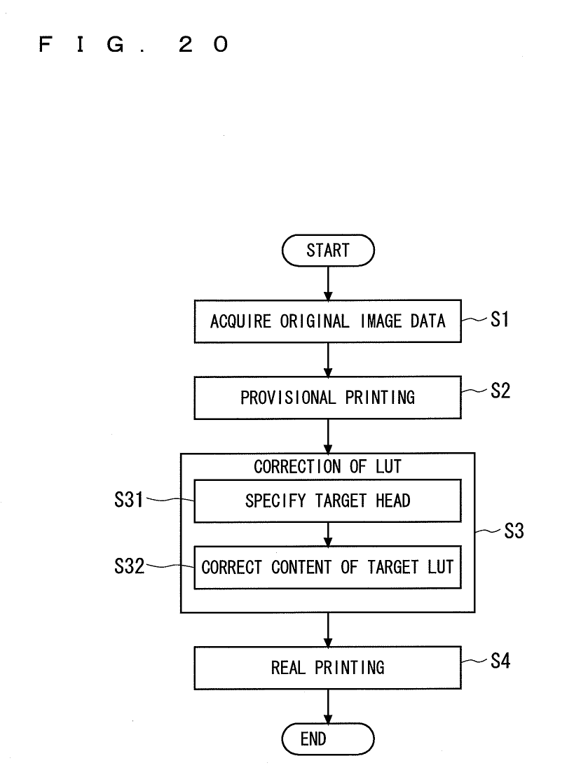

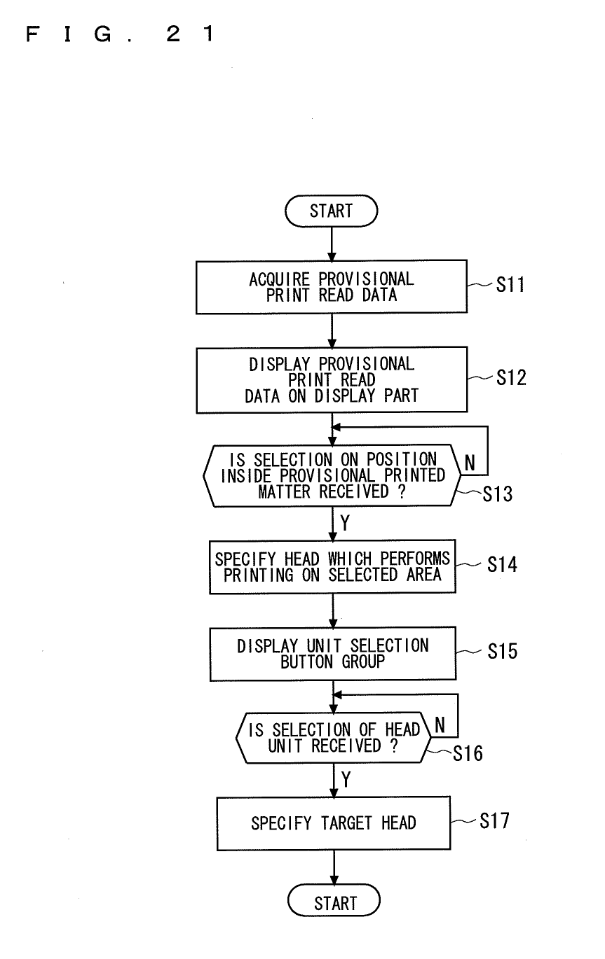

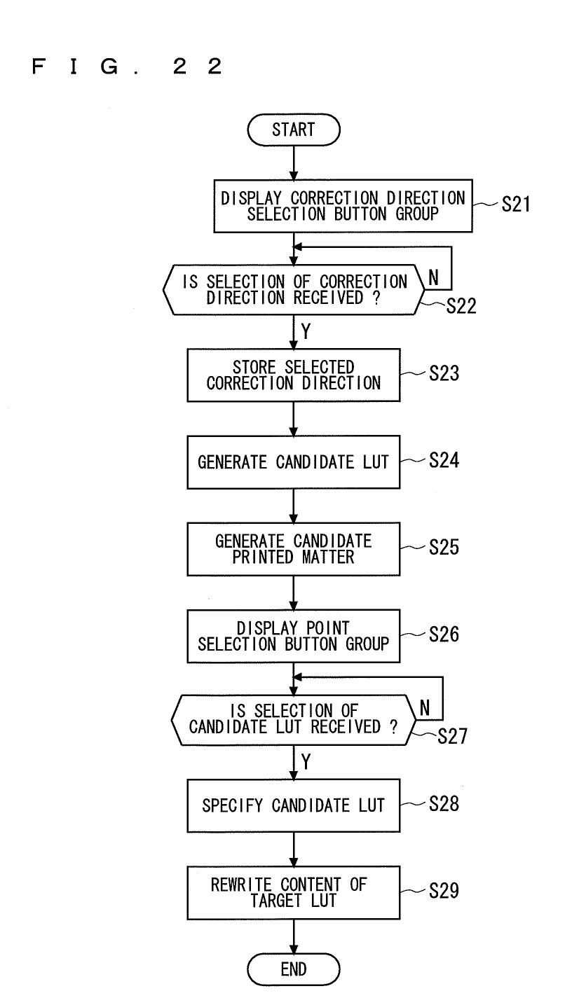

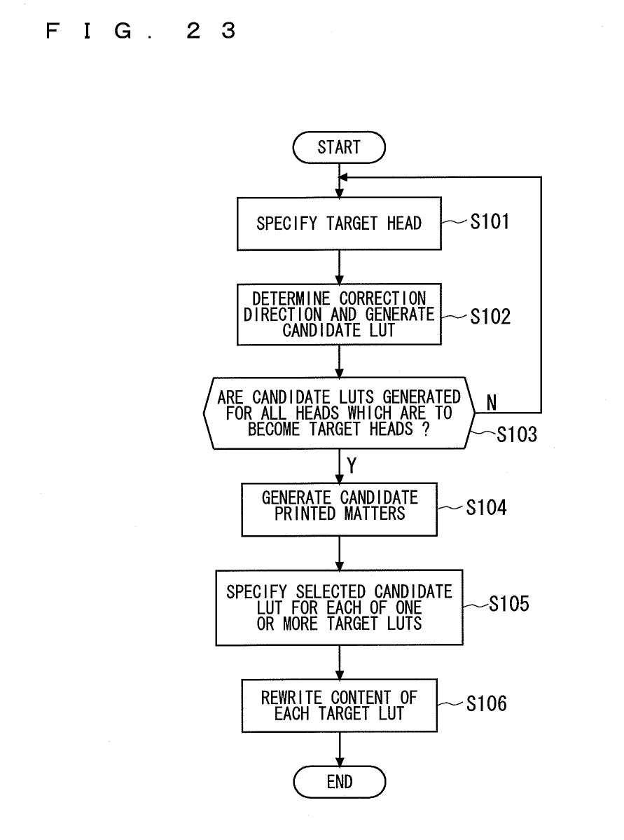

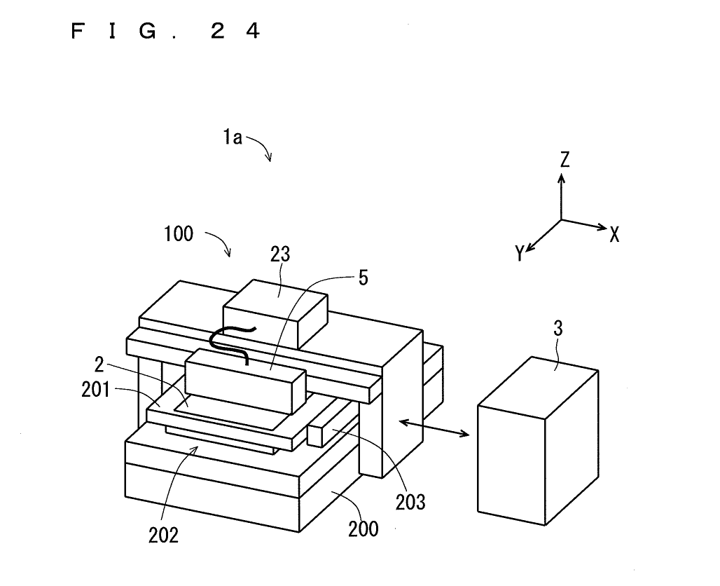

### BRIEF DESCRIPTION OF DRAWINGS

[FIG. 1] is a perspective view showing an appearance of a printing apparatus;

[FIG. 2] is a bottom plan view showing an ejection part;

[FIG. 3] is a bottom plan view showing a head unit;

[FIG. 4] is a plan view schematically showing how a printing medium is at some midpoint in a printing operation;

[FIG. 5] is a block diagram showing a hardware structure of a control device;

[FIG. 6] is a block diagram showing a functional constitution implemented in the control device;

[FIG. 7] is a graph showing a relation between an input value and an output value in an LUT;

[FIG. 8] is a graph showing a relation between an input value and an output value in an LUT;

[FIG. 9] is a graph showing a relation between an input value and an output value in an LUT;

[FIG. 10] is a view used for explanation of the principle of the shading compensation;

[FIG. 11] is a view used for explanation of the principle of the shading compensation;

[FIG. 12] is a block diagram showing functional constitution implemented in the control device;

[FIG. 13] is a view showing an exemplary configuration of a provisional print read data display screen;

[FIG. 14] is a view showing an exemplary configuration of the provisional print read data display screen on which a unit selection button group is displayed;

[FIG. 15] is a view showing an exemplary configuration of the provisional print read data display screen on which a correction direction selection button group is displayed;

[FIG. 16] is a view showing an exemplary constitution of a correspondence table;

[FIG. 17] is a graph showing a relation between an input value and an output value on a candidate LUT;

[FIG. 18] is a graph showing a relation between an input value and an output value on a candidate LUT;

[FIG. 19] is a view showing an exemplary configuration of the provisional print read data display screen on which a point selection button group is displayed;

[FIG. 20] is a flowchart showing a flow of the printing operation performed in the printing apparatus;

[FIG. 21] is a flowchart showing an operation flow for specifying a target head;

[FIG. 22] is a flowchart showing an operation flow for correcting a target LUT;

[FIG. 23] is a flowchart showing an operation flow in a case where a plurality of LUTs are corrected; and

[FIG. 24] is a perspective view showing an appearance of a printing apparatus in accordance with a variation.

### BEST MODE FOR CARRYING OUT THE INVENTION

<1. Printing Apparatus 1>

<1-1. Overall Structure>

With reference to FIG. 1, discussion will be made on a constitution of a printing apparatus 1 in accordance with the preferred embodiment of the present invention. FIG. 1 is a perspective view showing an appearance of the printing apparatus 1.

The printing apparatus 1 is an apparatus for performing inkjet color printing on a printing medium (e.g., a sheet base having liquid repellency, such as a film) 2, and comprises a body 100 and a control device 3 for controlling all constituent elements of the body 100.

The body 100 comprises a transfer part 4 for transferring the printing medium 2 in a predetermined direction (Y direction) and an ejection part 5 for ejecting fine droplets of ink toward the printing medium 2 transferred by the transfer part 4, to thereby print an image on the printing medium 2. The body 100 further comprises an image pickup part 6 for picking up an image of an area (printing area) of the printing medium 2 on which the image is printed by the ejection part 5.

<Transfer Part 4>

The transfer part 4 comprises a plurality of rollers 41 arranged in the Y direction and printing medium holding parts 42 provided at both ends of the plurality of rollers 41. The printing medium holding part 42 provided on the (+Y) side of the plurality of rollers 41 holds the roll-type printing medium 2 (feed roll) and serves as a printing medium feeding part. The printing medium holding part 42 provided on the (−Y) side of the plurality of rollers 41 holds the roll-type printing medium (wind-up roll) and serves as a printing medium wind-up part. Hereafter, the “printing medium 2” refers to a portion thereof at some midpoint of transfer (i.e., a portion of the printing medium 2 on the plurality of rollers 41).

On one of the plurality of rollers 41, provided is an encoder 43 for detecting a movement speed of the printing medium 2 in a scan direction. The control device 3 controls the rotation of a motor of the printing medium holding part 42 provided on the (−Y) side on the basis of an output of the encoder 43. The printing medium 2 can be thereby moved at constant speed in the (−Y) direction. Further, the control device 3 controls the rotation of a motor of the printing medium holding part 42 provided on the (+Y) side to give the printing medium 2 a load toward the (+Y) direction. The printing medium 2 can be thereby moved on the plurality of rollers 41 smoothly without rippling.

<Ejection Part 5>

The body 100 comprises a frame 22 which is fixed onto a base 21 and arranged across the plurality of rollers 41. The ejection part 5 is fixed to the frame 22 so as to be positioned above (on the (+Z) side of) the plurality of rollers 41. The frame 22 is provided with a light source 23. Light from the light source 23 is guided to the inside of the ejection part 5 through a bundle-type optical fiber 24.

Herein, with reference to FIG. 2, discussion will be made on a constitution of the ejection part 5. FIG. 2 is a bottom plan view showing the ejection part 5.

The ejection part 5 comprises a plurality of (four in this preferred embodiment) head units 51 which are fixed onto an ejection part body 50 and arranged along the Y direction. The four head units 51 eject ink of different colors. Specifically, a head unit 51 disposed on the most (+Y) side ejects ink of K (black). Another head unit 51 disposed next the head unit 51 for K (black) on the (−Y) side ejects ink of C (cyan). Still another head unit 51 disposed next the head unit 51 for C (cyan) on the (−Y) side ejects ink of M (magenta). Yet another head unit 51 disposed on the most (−Y) side ejects ink of Y (yellow). The ink of each color includes an ultraviolet curing agent and has ultraviolet curability. The number of head units 51 included in the ejection part 5 is not limited to four. Besides the above four head units 51, for example, head units 51 for ink of light cyan, light magenta, white, and the like may be further provided.

The ejection part 5 further comprises a light emitting part 52 which is provided on the (−Y) side of the four head units 51. The light emitting part 52, in which the optical fiber 24 connected to the light source 23 is disposed along the X direction, emits light to a linear area extending along the X direction on the printing medium 2.

In the printing apparatus 1, the head units 51 and light emitting part 52 are provided over an entire printing area on the printing medium 2 in the X direction (width direction) orthogonal to the printing direction.

Next, with reference to FIG. 3, discussion will be made on a constitution of the head unit 51. FIG. 3 is a bottom plan view showing the head unit 51.

The head unit 51 comprises N (N is any integer larger than 1, and for example, N=21) heads 511 arranged in a staggered manner entirely in the width direction (X direction) of the printing medium 2.

Each of the heads 511 ejects ink droplets from its outlets toward the printing medium 2. Specifically, each of the heads 511 is a piezoelectric driving type head and provided with a plurality of outlets 5111 on a lower surface (surface on the (−Z) side) thereof, which are arranged along the width direction (X direction). Each of the outlets 5111 is provided with a discharge flow channel which guides ink thereto, and in the discharge flow channel, a driving part which is a piezoelectric element (piezo element) is disposed near the outlet 5111. When an ejection signal is given to the driving part, the driving part becomes deformed and the volumetric capacity of the discharge flow channel near the outlet 5111 (more specifically, the volumetric capacity of a chamber provided in a portion of the discharge flow channel near the outlet 5111) decreases. This gives pressure to the ink near the outlet 5111 (specifically, ink in the chamber of the discharge flow channel which guides the ink to the outlet 5111) and fine droplets of the ink are ejected from the outlet 5111. Then, the form of the driving part becomes normal again, and the volumetric capacity of the discharge flow channel near the outlet 5111 thereby become normal again and the ink as much as the ejected fine droplets of the ink is supplied to the discharge flow channel.

<Image Pickup Part 6>

Referring back to FIG. 1, the image pickup part 6 comprises a line sensor which is disposed on the lower (−Y) side in a transfer direction of the printing medium 2 and picks up an image of a linear area parallel to the X direction (width direction) orthogonal to the printing direction. By picking up an image of the printing medium (printed matter) 2 after printing, being transferred by the transfer part 4, picked-up image data of the printed matter is acquired.

<1-2. Overview of Printing Operation>

With reference to FIG. 4, discussion will be made on an overview of the printing operation performed in the printing apparatus 1. FIG. 4 is a plan view schematically showing how the printing medium 2 is at some midpoint in the printing operation.

While the printing operation is performed, the control device 3 (specifically, a print control part 303 included in the control device 3 (see FIG. 6)) controls the transfer part 4 to move the printing medium 2 in the printing direction (specifically, in the Y direction of FIG. 1, which is a direction substantially orthogonally crossing an arrangement direction of the plurality of outlets 5111 in each of the heads 511). The print control part 303 further controls a plurality of driving parts for the N heads 511 provided in each of the head units 51 on the basis of image data to be printed on the printing medium 2, concurrently with the move of the printing medium 2. Then, the fine droplets of ink are ejected from the outlets 5111 and given onto the printing medium 2 every time when the printing medium 2 moves by a predetermined distance in the printing direction. An image can be thereby printed on the printing medium 2.

The N heads 511, however, are arranged across the entire printing area in the width direction (specifically, across the entire width of the printing medium 2 in the width direction) in each of the head units 51, as discussed above. Therefore, printing of the image on the printing medium 2 is completed when the printing medium 2 passes below the ejection part 5 only once (in the so-called one-pass method).

In the one-pass printing method, when all the N heads 511 are used for printing as shown in FIG. 4, for example, each of N strip-like printing areas 20 which are obtained by equally dividing the printing medium 2 by N in the X direction (width direction) is printed by any one of the N heads 511 included in each of the head units 51. For example, the center strip-like printing area 20 is printed by one of the N heads 511 included in each of the head units 51, which is disposed at the center.

All the N heads 511, however, are not always used for printing and the number of heads to be used for printing depends on the size of the printing medium 2 in the width direction. When printing is performed on the printing medium 2 having a width which corresponds to the width of five heads 511, for example, only five of the N heads 511 included in each of the head units 51, which are disposed, for example, at the center thereof, are used for printing.

Thus, in the one-pass printing method, since the strip-like printing areas 20 are printed by the different heads 511, if there is a variation in the ejection performance among the heads 511, this causes inconsistencies in density (head level difference), i.e., a phenomenon in which only a certain strip-like printing area 20 has higher (or lower) density as compared with the other areas. When one of the N heads 511 included in the head unit 51 for ejecting ink of C (cyan) ejects more ink as compared with the other heads 511, for example, the strip-like printing area 20 of which the head 511 in question is in charge is printed with the color of C (cyan) darker than that for the other strip-like printing areas 20. In the control device 3, implemented are function parts to avoid occurrence of such head level difference as discussed below.

<2. Control Device 3>

<2-1. Hardware Structure>

With reference to FIG. 5, discussion will be made on a hardware structure of the control device 3. FIG. 5 is a block diagram showing the hardware structure of the control device 3.

The control device 3 has a constitution of general computer, in which a control part 31, a display part 32, an operation part 33, and a storage part 34 are connected with one another by a bus line 35.

The control part 31 is, for example, a CPU. The control part 31 executes a program P stored in the storage part 34, to thereby implement various functions described below in the control device 3. The program P may be provided through a recording medium such as a CD-ROM or the like, or via a communication line such as a network or the like.

The display part 32 is a liquid crystal display or the like and visibly outputs image data or the like which is generated by the control part 31. On the other hand, the operation part 33 sends various command signals to the control part 31 in accordance with various operations of a user. As the operation part 33, a pointing device such as a mouse or the like, a keyboard, or the like may be used. The operation part 33 may be unified with the display part 32 by using a touch panel. In the present preferred embodiment, the display part 32 and the operation part 33 are unified by using a touch panel.

The storage part 34 is a memory device such as a semiconductor memory, a hard disc, or the like. In the storage part 34, stored are various information such as the program P to be executed by the control part 31, information required to execute the program P, image data to be printed, tables to be used for the shading compensation discussed later, and the like.

<2-2. Functional Constitution>

<2-2-1. Basic Functional Constitution>

A functional constitution implemented in the control device 3 will be discussed, with reference to FIG. 6. FIG. 6 is a block diagram showing the functional constitution implemented in the control device 3. The function parts included in the control part 31 may be implemented by computation performed by the control part 31 in accordance with the program P stored in the storage part 34 or may be implemented by dedicated hardware.

The control part 31 comprises an original image data acquisition part 301 for acquiring image data (hereinafter, referred to as “original image data 7”) to be printed on the printing medium 2, a shading compensation part 302 for performing the shading compensation discussed later on the original image data 7, and the print control part 303 for causing the body 100 to perform a printing operation on the basis of the image data after being subjected to the shading compensation.

<Original Image Data Acquisition Part 301>

The original image data acquisition part 301 acquires the original image data 7. The original image data acquisition part 301 may acquire the original image data 7 in any manner. For example, the original image data acquisition part 301 may receive the original image data 7 via online from an external device, or may read the original image data 7 from a transportable storage medium such as a DVD or the like, or by using a scanner. Alternatively, there may be a case where the original image data 7 is stored in a file server or the like which is connected to the apparatus via a network and read out from the file server.

<Shading Compensation Part 302>

The shading compensation part 302 performs the shading compensation on the original image data 7 acquired by the original image data acquisition part 301 to suppress occurrence of inconsistencies in density (head level difference) due to the difference in the ejection performance among the plurality of heads 511 included in the ejection part 5. Specific discussion will be made later on the shading compensation.

<Print Control Part 303>

The print control part 303 controls the transfer part 4 and the ejection part 5 to perform a printing operation on the basis of the image data (corrected image data 8) after being subjected to the shading compensation performed by the shading compensation part 302. More specifically, the print control part 303 causes the transfer part 4 to move the printing medium 2 in the printing direction. On the other hand, the print control part 303 performs halftone screening on the corrected image data 8, to thereby generate a print image, and causes the N heads 511 included in each of the head units 51 in the ejection part 5 to eject ink on the basis of the generated print image. The original image data 7 can be thereby printed on the printing medium 2.

The original image data acquisition part 301, the shading compensation part 302, and the print control part 303 constitute the basic functions for performing the printing operation.

<2-2-2. Shading Compensation>

Herein, discussion will be made on the shading compensation. The shading compensation is performed by using a plurality of look-up tables (LUTs) 9 stored in the storage part 34.

<LUT 9>

First, discussion will be made on the LUTs 9 sued for the shading compensation. The plurality of LUTs are provided correspondingly to the plurality of heads 511 included in the ejection part 5, respectively.

As discussed above, the ejection part 5 comprises the head units 51 for ejecting ink of K (black), C (cyan), M (magenta), and Y (yellow), respectively, and each of the head units 51 comprises N heads 511. In the storage part 34, formed are LUT groups 90 associated with the head units 51, respectively, and to each of the LUT groups 90, N LUTs 9 belong, which are associated with the N heads 511, respectively, which belong to each of the head units 51 corresponding to the LUT groups 90.

Each of the N LUTs 9 included in each of the LUT groups 90 has a content reflecting the ejection performance of the corresponding head 511. When the amount of ejected ink from a head 511 (normal head) is a specified normal value, the corresponding LUT 9 gives an output value y (y=Ko*x) (where the sign “a” represents multiplication, and the same applies to the following) obtained by multiplying an input value x by a normal coefficient Ko (such an LUT 9 is hereinafter also referred to as a “normal LUT”), as shown in FIG. 7. The normal coefficient Ko can take any value within a range of values from 0 to 1, but it is particularly preferable to take a range of values from 0.2 to 0.8. When the normal coefficient Ko takes a value within such a range of values, even if there is an overejection head or an underejection head, the LUT 9 can be adapted thereto only by decreasing (or increasing) the coefficient. When Ko=0.5, for example, 50% of an input value x is given as an output value y through this LUT 9.

On the other hand, when the amount of ejected ink from a head 511 (overejection head) is larger than the specified normal value, the corresponding LUT 9 gives an output value y (y=Ka*x) obtained by multiplying an input value x by a coefficient Ka (Ka<

Ko) smaller than the normal coefficient Ko, as shown in FIG. 8. Specifically, through this LUT 9, given is an output value y which is smaller than the output value y given through the normal LUT 9 with respect to the same input value x. As the deviation of the amount of ejected ink from the specified normal value becomes larger, however, a value of the coefficient Ka differs more largely from the normal coefficient Ko, as it can be clearly seen below. When Ka=0.4, for example, 40% of an input value x is given as an output value y through this LUT 9.

Further, when the amount of ejected ink from a head 511 (underejection head) is smaller than the specified normal value, the corresponding LUT 9 gives an output value y (y=Kb*x) obtained by multiplying an input value x by a coefficient Kb (Kb>Ko) larger than the normal coefficient Ko, as shown in FIG. 9. Specifically, through this LUT 9, given is an output value y which is larger than the output value y given through the normal LUT 9 with respect to the same input value x. As the deviation of the amount of ejected ink from the specified normal value becomes larger, however, a value of the coefficient Kb differs more largely from the normal coefficient Ko. When Kb=0.6, for example, 60% of an input value x is given as an output value y through this LUT 9.

<Principle of Shading Compensation>

The shading compensation part 302 performs the shading compensation on the original image data 7 by using the plurality of LUTs 9 stored in the storage part 34.

Herein, specific discussion will be made on the principle of the shading compensation, with reference to FIGS. 10 and 11. FIGS. 10 and 11 are views used for explanation of the principle of the shading compensation. FIG. 10 shows how the printing medium (printed matter) 2 after printing is when the printing is performed on the basis of the original image data 7 on which no shading compensation is performed. FIG. 11 shows how the printed matter 2 obtained by printing is when the printing is performed on the basis of the original image data 7 (corrected image data 8) after being subjected to the shading compensation.

As discussed above, in the one-pass printing method, the N strip-like printing areas 20 defined on the printing medium 2 are printed by the different heads 511, respectively (see FIG. 4). The shading compensation part 302 divides the original image data 7 (more specifically, each of a plurality of color component data, i.e., each of C (cyan) component data, M (magenta) component data, Y (yellow) component data, and K (black) component data which are generated on the basis of the original image data 7) into partial areas (strip-like data areas 70) corresponding to the strip-like printing areas 20, respectively, and compensates tone values of pixels in each strip-like data area 70 by using the LUT 9 associated with the head 511 which is in charge of the corresponding strip-like printing area 20 (shading compensation).

It is assumed, for example, that one (specified head 511t) of the N heads 511 included in the head unit 51 (specified head unit 51t) for ejecting ink of C (cyan) is an overejection head. Then, in the printed matter 2 obtained without performing the shading compensation, the head level difference disadvantageously occurs in the strip-like printing area 20t of which the specified head 511t is in charge (FIG. 10).

When the shading compensation is performed on the original image data 7, there occurs no head level difference in the generated printed matter 2. Specifically, when the shading compensation is performed, the strip-like data area 70t corresponding to the strip-like printing area 20t of which the specified head 511t is in charge is corrected by using the LUT 9 associated with the specified head 511t. As discussed above, the LUT 9 corresponding to the overejection head 511 gives an output value smaller than that given through the normal LUT 9 with respect to the same input value (see FIG. 8). Therefore, the tone values of the pixels in the strip-like data area 70t are corrected to be smaller than those in the other areas. When printing is performed on the basis of the corrected image data 8 after being thus corrected, since the strip-like data area 70t after being corrected to have the tone values smaller than those in the other areas is printed by the specified head 511t which ejects more ink as compared with the other heads 511 which are in charge of the other areas, there occurs no head level difference in the generated printed matter 2 (FIG. 11).

Thus, by performing the shading compensation, it is possible to prevent the head level difference from occurring. In order to reliably prevent the head level difference, however, it is premised that the LUTs 9 stored in the storage part 34 accurately reflect the respective ejection performances of the heads 511 to be used for printing.

The ejection performances of the heads 511, however, are changed in a subtle way depending on the environmental conditions (e.g., temperature, humidity, and the like) at the printing operation. In other words, the ejection performances of the heads 511 are changed every time the printing operation is performed. Therefore, every time the printing operation is performed, it is necessary to correct the LUTs 9 stored in the storage part 34 so as to have contents reflecting the ejection performances of the heads 511 at that time. In the control device 3, the functions to correct the contents of the LUTs 9 are implemented every time when the printing operation is performed.

<3. Correction of LUT 9>

Referring back to FIG. 6, discussion will be made on a constitution to implement functions relating to the above-discussed correction of the LUTs 9.

The control part 31 comprises a target head specifying part 304 and an LUT correction part 305 for implementing the above functions, as well as the original image data acquisition part 301, the shading compensation part 302, and the print control part 303. With reference to FIG. 12, specific discussion will be made on respective constitutions of the function parts 304 and 305.

<3-1. Target Head Specifying Part 304>

The target head specifying part 304 specifies a head 511 to be corrected (hereinafter, referred to as a “target head 511”). Herein, when an LUT 9 has to be corrected, the corresponding head 511 (the ejection performance at the present time of which is not in agreement with the content of the corresponding LUT 9) is determined to be a target head 511. When printing is performed by using a head 511 whose ejection performance is not in agreement with the content of the corresponding LUT 9, there occurs a head level difference in the strip-like printing area 20 of which the head 511 is in charge.

The target head specifying part 304 comprises a provisional print read data acquisition part 341, a provisional print read data display control part 342, a selected position corresponding head specifying part 343, and a correction target head narrowing-down part 344.

<Provisional Print Read Data Acquisition Part 341>

The provisional print read data acquisition part 341 acquires provisional print read data 10. The “provisional print read data 10” refers to data acquired by reading a printed matter (provisional printed matter) 2 obtained by a printing operation (provisional printing operation) which is performed before the real printing so as to check the condition of the print result. The provisional printing is a printing operation performed on the basis of the corrected image data 8 obtained by performing the shading compensation using the uncorrected LUT 9. After the provisional printing is performed, the provisional print read data acquisition part 341 causes the image pickup part 6 to read the provisional printed matter 2 and acquire the obtained read data as the provisional printed matter picked-up image data 10.

<Provisional Print Read Data Display Control Part 342>

The provisional print read data display control part 342 displays the provisional printed matter picked-up image data 10 on the display part 32. Specifically, the provisional print read data display control part 342 displays a “provisional print read data display screen 300” described below on the display part 32 and then displays the provisional print read data 10 in a “provisional printed matter display area 310” defined in the provisional print read data display screen 300.

<Provisional Print Read Data Display Screen 300>

Herein, with reference to FIG. 13, discussion will be made on an exemplary configuration of the provisional print read data display screen 300. FIG. 13 is a view showing an exemplary configuration of the provisional print read data display screen 300. Since the display part 32 and the operation part 33 are unified by using a touch panel, as discussed above, the user can input various commands by touching the provisional print read data display screen 300 by his fingers.

At the center of the provisional print read data display screen 300, defined is a rectangular provisional printed matter display area 310. Inside the provisional printed matter display area 310, the provisional printed matter picked-up image data 10 are displayed. The entire width direction 311 of the provisional printed matter display area 310 corresponds to the entire width direction of the provisional print read data 10 (i.e., the entire width direction of the provisional printed matter 2). In other words, the entire width direction of the provisional print read data 10 (i.e., the entire width direction of the provisional printed matter 2) can be accommodated inside the provisional printed matter display area 310 without fail.

To the side of the provisional printed matter display area 310, scroll buttons 320 are displayed. The scroll buttons 320 are GUI components to move a display area as necessary when the entire longitudinal direction of the provisional print read data 10 (i.e., the entire printing direction (orthogonal to the width direction) of the provisional printed matter 2) cannot be accommodated in the height direction (orthogonal to the width direction 311) 312 of the provisional printed matter display area 310. The user can move the display area by touching the scroll buttons 320 by his finger.

Below the provisional printed matter display area 310, page selection buttons 330 are displayed. The page selection buttons 330 are GUI components to select a page to be displayed in the provisional printed matter display area 310 when the provisional printed matter 2 consists of a plurality of pages. The user can display any given page of the provisional printed matter 2 in the provisional printed matter display area 310 by touching the page selection buttons 330 by his finger.

Further, below the provisional printed matter display area 310, a confirm button 341 and a real print start button 342 are displayed. The confirm button 341 is a GUI component to receive an input of command to confirm various operations inputted by the user. The user can confirm the early input by touching the confirm button 341 by his finger. On the other hand, the real print start button 342 is a GUI component to receive an input of command to start execution of the real printing. The user can start execution of the real printing by touching the real print start button 342 by his finger.

Furthermore, below the provisional printed matter display area 310, an exit button 350 is displayed. The exit button 350 is a GUI component to receive an input of command to finish the display of the provisional print read data display screen 300. The user can close the provisional print read data display screen 300 by touching the exit button 350 by his finger.

<Selected Position Corresponding Head Specifying Part 343>

Referring back to FIG. 12, the selected position corresponding head specifying part 343 receives the selection of a position in the provisional printed matter 2 from the user through the above-discussed provisional print read data display screen 300 and specifies the head 511 which performed printing on the position (selected position) in the provisional printed matter 2, which is received.

Referring back to FIG. 13, discussion will be made on how the selected position corresponding head specifying part 343 receives the selection of the user and specifies the head 511 which performed printing on the position which is received.

As discussed above, the selected position corresponding head specifying part 343 receives the selection of the position in the provisional printed matter 2 from the user through the provisional print read data display screen 300. In other words, the provisional print read data display screen 300 serves as a receiving screen for receiving the position selection from the user.

In the one-pass printing method, as discussed above, among the N heads 511 included in each of the head units 51, the heads 511 as many as the number in accordance with the size of the width direction of the printed matter 2 are used for the printing. It is herein assumed that M (M≦N) heads 511 are used for the printing. The M strip-like printing areas 20 obtained by dividing the width direction of the printed matter 2 by M are printed by the different heads 511, respectively.

The selected position corresponding head specifying part 343 displays the split lines 313 for dividing the provisional printed matter display area 310 by M in the width direction 311. Then, the split lines 313 are displayed on positions corresponding to the boundaries of the strip-like printing areas 20 in the printed matter 2 displayed in the provisional printed matter display area 310. Specifically, a divided area 314 defined by adjacent two split lines 313 corresponds to a strip-like printing area 20 printed by each of the M heads 511 used for printing of the printed matter 2. In the selected position corresponding head specifying part 343, stored are each of the divided areas 314 and the head 511 which prints the strip-like printing area 20 corresponding to the divided area 314, being associated with each other.

In each of the head units 51, however, there is one head 511 which prints the strip-like printing area 20 corresponding to each of the divided areas 314. Therefore, the heads 511 as many as the number of head units 51 (four heads 511 in the present preferred embodiment) are associated with each of the divided areas 314.

The provisional printed matter display area 310 serves as a receiving area for receiving the position selection from the user. Specifically, when the user touches a given position in the provisional printed matter display area 310 by his finger, the selected position corresponding head specifying part 343 first specifies which one of the M divided areas 314 the selected position belongs to. After the divided area 314 to which the selected position belongs is specified, the selected area corresponding head specifying part 343 further specifies the four heads 511 associated with the specified divided area 314. The four heads 511 performed the printing on the position selected by the user. In other words, the heads 511 which performed the printing on the selected position received from the user are thus specified.

The user, however, selects a problematic position (for example, a position where a head level difference is recognized to occur) while looking at the provisional printed matter picked-up image data 10 displayed in the provisional printed matter display area 310. For selecting the position, the user can select an area while manipulating the scroll buttons 320 and the page selection buttons 330 as appropriate to display any given area in any given page in the provisional printed matter display area 310. When the user selects a position while displaying a portion using many colors or a portion with a lot of solid fills in the provisional printed matter display area 310, for example, the user can prevent himself from missing the head level difference.

Though all the four heads 511 specified by the selected area corresponding head specifying part 343 may be determined as the target heads 511, the specified four heads 511 are further narrowed down to one and the narrowed-down head 511 is determined as the target head 511 in the present preferred embodiment.

<Correction Target Head Narrowing-down Part 344>

Referring back to FIG. 12, the correction target head narrowing-down part 344 narrows down the four heads 511 specified by the selected position corresponding head specifying part 343 to one head 511 to be corrected. Specifically, the correction target head narrowing-down part 344 causes the user to select one of the four heads 511 specified by the selected position corresponding head specifying part 343 and specifies the selected head 511 as the head 511 to be corrected (target head 511).

With reference to FIG. 14, discussion will be made on how the correction target head narrowing-down part 344 narrows down the four heads 511 to one head 511 to be corrected.

The correction target head narrowing-down part 344 displays a unit selection button group 360 on the provisional print read data display screen 300. The unit selection button group 360 includes a unit selection button 361 for selecting the head unit 51 which ejects ink of Y (yellow), a unit selection button 362 for selecting the head unit 51 which ejects ink of M (magenta), a unit selection button 363 for selecting the head unit 51 which ejects ink of C (cyan), a unit selection button 364 for selecting the head unit 51 which ejects ink of K (black), and a cancel button 365 for canceling the selection of the unit. The cancel button 365 may be displayed from the point in time when any one of the unit selection buttons 361 to 364 is selected.

The unit selection button group 360 is a GUI component to receive the selection of the head unit 51 to be corrected, from the user. Specifically, when the user selects any one of the unit selection buttons 361 to 364 and touches the button by his finger, the correction target head narrowing-down part 344 receives the selecting operation and stores the selected head unit 51 as the head unit 51 to be corrected. Then, the correction target head narrowing-down part 344 stores one of the four heads 511 specified by the selected position corresponding head specifying part 343, which is included in the head unit 51 to be corrected, as the target head 511.

The user selects the head unit 51 to be corrected while looking at the tint of the head level difference occurring at the early-selected position in the provisional printed matter picked-up image data 10 displayed in the provisional printed matter display area 310. When the head level difference in which the printed color of Y (yellow) is darker (or lighter) than that in the other areas is recognized to occur at the early-selected position, for example, the user selects the head unit 51 for ejecting ink of Y (yellow) as the head unit 51 to be corrected.

If such display control is performed as to display a red line surrounding the early-selected divided area 314 when the unit selection button group 360 is displayed, the user can appropriately select the unit while naturally checking the area in which the head level difference to be corrected occurs.

<3-2. LUT Correction Part 305>

Referring back to FIG. 12, the LUT correction part 305 corrects the LUT 9 (hereinafter, referred to as a “target LUT 9”) corresponding to the target head 511 specified by the target head specifying part 304. The LUT correction part 305 comprises a correction direction determination part 351, a candidate LUT generation part 352, a candidate printed matter generation part 353, an LUT selection receiving part 354, and an LUT rewrite part 355.

<Correction Direction Determination Part 351>

The correction direction determination part 351 determines a direction in which the target LUT 9 is to be corrected. Specifically, the correction direction determination part 351 causes the user to select in which direction, the (+) direction or the (−) direction, the target LUT 9 is to be corrected.

“Correcting the LUT 9 in the (+) direction” refers to correction of the coefficient value of the LUT 9 to a larger value. Conversely, “correcting the LUT 9 in the (−) direction” refers to correction of the coefficient value of the LUT 9 to a smaller value.

In a case where an ejection area of which the target head 511 is in charge is printed with a darker color as compared with the other areas, the target head 511 ejects excessive ink. Therefore, in this case, it is necessary to correct the target LUT 9 in the (−) direction (in other words, correct the coefficient value of the LUT 9 to a smaller value). When the coefficient value of the LUT 9 is corrected to a smaller value, since the tone values of the pixels in the strip-like data area 70 corresponding to the strip-like printing area 20 of which the target head 511 is in charge are corrected to smaller tone values, the head level difference due to the overejection of the target head 511 is resolved.

Conversely, in a case where an ejection area of which the target head 511 is in charge is printed with a lighter color as compared with the other areas, the target head 511 ejects too little ink. Therefore, in this case, it is necessary to correct the target LUT 9 in the (+) direction (in other words, correct the coefficient value of the LUT 9 to a larger value). When the coefficient value of the LUT 9 is corrected to a larger value, since the tone values of the pixels in the strip-like data area 70 corresponding to the strip-like printing area 20 of which the target head 511 is in charge are corrected to larger tone values, the head level difference due to the underejection of the target head 511 is resolved.

With reference to FIG. 15, discussion will be made on how the correction direction determination part 351 causes the user to select the correction direction.

The correction direction determination part 351 displays a correction direction selection button group 370 on the provisional print read data display screen 300. The correction direction selection button group 370 includes a direction selection button 371 for selecting correction of the target LUT 9 in the (+) direction, a correction direction selection button 372 for selecting correction of the target LUT 9 in the (−) direction, and a cancel button 373 for cancelling an already-performed selecting operation.

The correction direction selection button group 370 is a GUI component to receive the selection of the correction direction from the user. Specifically, when the user selects either one of the correction direction selection buttons 371 and 372 and touches the button by his finger, the correction direction determination part 351 receives the selecting operation and stores the selected direction as the correction direction.

The user selects the correction direction while looking at the tint of the head level difference occurring at the early-selected area in the provisional printed matter picked-up image data 10 displayed in the provisional printed matter display area 310. Specifically, as discussed above, when the selected area is printed with a darker color as compared with the other areas, the user selects the (−) direction as the correction direction of the target LUT 9. Conversely, when the selected area is printed with a lighter color as compared with the other areas, the user selects the (+) direction as the correction direction of the target LUT 9.

If the correction direction selection button group 370 is so displayed as to sandwich the early-selected unit selection button 370, the user can appropriately select the correction direction while naturally checking what color the selected head unit 51 is used for.

<Candidate LUT Generation Part 352>

Referring back to FIG. 12, the candidate LUT generation part 352 generates a plurality of LUTs which are to become correction candidates (hereinafter, referred to as “candidate LUTs 91”) of the target LUT 9. Specifically, the candidate LUT generation part 352 generates an LUT for giving an output value y (y=Km*x) obtained by multiplying an input value x by a correction coefficient Km and acquires the LUT as the candidate LUT 9. A value of the correction coefficient Km is defined by the following Eq. (1).

Km=Q*Ki (Eq. 1)

In (Eq. 1), “Ki” represents a coefficient of an uncorrected target LUT 9. Specifically, the uncorrected target LUT 9 gives an output value y (y=Ki*x) with respect to an input value x while the candidate LUT 91 gives an output value y (y=Km*x=Q*(Ki*x)) with respect to the input value x.

On the other hand, “Q” in (Eq. 1) represents an actual value defining the degree of correction from the target LUT 9. A specific value of the actual value Q depends on a correction point. A relation between the correction point and the actual value Q is defined by a correspondence table T stored in the storage part 34.

FIG. 16 shows an exemplary constitution of the correspondence table T. As shown in FIG. 16, with respect to the (+) correction direction, values (1.1 to 2.0) larger than 1 are defined as the actual value Q and the actual value Q increases as the correction point becomes larger. Further, with respect to the (−) correction direction, values (0 to 0.9) smaller than 1 are defined as the actual value Q and the actual value Q decreases as the correction point becomes larger.

Therefore, in the case of (+) correction direction, as shown in FIG. 17, if the uncorrected target LUT 9 gives the output value y (y=Ki*x) with respect to the input value x, a first candidate LUT 911 obtained by correcting the uncorrected target LUT 9 by +1 point gives an output value y (y=(1.1*Ki)*x) with respect to the input value x. A second candidate LUT 912 obtained by correcting the uncorrected target LUT 9 by +2 points gives an output value y (y=(1.25*Ki)*x) with respect to the input value x. A third candidate LUT 913 obtained by correcting the uncorrected target LUT 9 by +3 points gives an output value y (y=(1.5*Ki)*x) with respect to the input value x. A fourth candidate LUT 914 obtained by correcting the uncorrected target LUT 9 by +4 points gives an output value y (y=(1.75*Ki)*x) with respect to the input value x. A fifth candidate LUT 913 obtained by correcting the uncorrected target LUT 9 by +5 points gives an output value y (y=(2.0*Ki)*x) with respect to the input value x.

On the other hand, in the case of (−) correction direction, as shown in FIG. 18, if the uncorrected target LUT 9 gives the output value y (y=Ki*x) with respect to the input value x, the first candidate LUT 911 obtained by correcting the uncorrected target LUT 9 by −1 point gives an output value y (y=(0.9*Ki)*x) with respect to the input value x. The second candidate LUT 912 obtained by correcting the uncorrected target LUT 9 by −2 points gives an output value y (y=(0.75*Ki)*x) with respect to the input value x. The third candidate LUT 913 obtained by correcting the uncorrected target LUT 9 by −3 points gives an output value y (y=(0.5*Ki)*x) with respect to the input value x. The fourth candidate LUT 914 obtained by correcting the uncorrected target LUT 9 by −4 points gives an output value y (y=(0.25*Ki)*x) with respect to the input value x. The fifth candidate LUT 913 obtained by correcting the uncorrected target LUT 9 by −5 points gives an output value y (y=(0*Ki)*x) with respect to the input value x.

Thus, the candidate LUT generation part 352 generates five candidate LUTs 91 obtained by correcting the target LUT 9 by 1 point, 2 points, 3 points, 4 points, and 5 points in the selected correction direction, respectively.

<Candidate Printed Matter Generation Part 353>

Referring back to FIG. 12, the candidate printed matter generation part 353 generates a candidate printed matter. Specifically, the candidate printed matter generation part 353 causes the shading compensation part 302 to perform the shading compensation processes using the plurality of candidate LUTs 91, respectively, generated by the candidate LUT generation part 352 on the original image data 7. Then, the candidate printed matter generation part 353 causes the print control part 303 to perform the printing operations on the basis of the pieces of corrected image data 8 obtained through the shading compensation processes, respectively. A plurality of printed matters which are obtained thus are the candidate printed matters.

<LUT Selection Receiving Part 354>

The LUT selection receiving part 354 causes the user to selects one of the plurality of candidate LUTs 9 generated for the target LUT 9 and specifies the selected candidate LUT 91 as a candidate LUT 91 to be rewritten as a replacement for the target LUT 9.

With reference to FIG. 19, discussion will be made on how the LUT selection receiving part 354 specifies the candidate LUT 91 to be rewritten as a replacement for the target LUT 9.

The LUT selection receiving part 354 displays a point selection button group 380 on the provisional print read data display screen 300. In the case of (+) correction direction, the point selection button group 380 includes a point selection button 381 for selecting the candidate LUT 91 obtained by correcting the target LUT 9 by +1 point, a point selection button 382 for selecting the candidate LUT 91 obtained by correcting the target LUT 9 by +2 points, a point selection button 383 for selecting the candidate LUT 91 obtained by correcting the target LUT 9 by +3 points, a point selection button 384 for selecting the candidate LUT 91 obtained by correcting the target LUT 9 by +4 points, a point selection button 385 for selecting the candidate LUT 91 obtained by correcting the target LUT 9 by +5 points, and a cancel button 386 for cancelling the selection of the point. In the case of (−) correction direction, similar point selection buttons with the sign “−” instead of “+” are displayed.

The point selection button group 380 is a GUI component to receive the selection of the correction point from the user. Specifically, when the user touches one of the selection buttons 381 to 385, the LUT selection receiving part 354 receives the selecting operation, and stores the corrected LUT 92 which is selected, as the candidate LUT 91 to be rewritten as a replacement for the target LUT 9, and deletes the candidate LUTs 91 which are not selected. The candidate LUT 91 which is specified by the LUT selection receiving part 354 as the candidate LUT 91 to be rewritten as a replacement for the target LUT 9 is hereinafter, referred to as a “selected candidate LUT 92”.

The user can select an optimum candidate LUT 91 for resolving the head level difference while looking at the plurality of candidate printed matters generated by the candidate printed matter generation part 353. When the early-selected area is printed with a darker color of ink as compared with the other areas to thereby cause the head level difference, for example, the respective areas in question in the plurality of candidate printed matters are printed with gradually lighter colors. Then, the user can select the corrected LUT 92 capable of appropriately resolving the head level difference by specifying one of the plurality of candidate printed matters, in which the head level difference in the area in question is appropriately resolved, and selecting the candidate LUT 91 which gives the specified candidate printed matter while looking at the plurality of candidate printed matters.

If the correction point selection button group 360 is displayed at the same position as the correction direction selection button group 370 is displayed, the user can perform a series of inputs for the selections without causing any feeling of strangeness.

<LUT Rewrite Part 355>

The LUT rewrite part 355 rewrites the content of the target LUT 9 with the content of the selected candidate LUT 92. Specifically, when the user touches the above-described confirm button 341 by his finger, the LUT rewrite part 355 rewrites the content of the target LUT 9 with the content of the selected candidate LUT 92. The target LUT 9 is thereby corrected to one reflecting the ejection performance of the corresponding head 511 at the present time.

<4. Operation Flow><4-1. Overall Operation Flow>

With reference to FIG. 20, discussion will be made on a flow of the printing operation performed in the printing apparatus 1. FIG. 20 is a flowchart showing the operation flow.

When the control device 3 receives a command of starting the printing operation from the user, the control device 3 starts the printing operation. Specifically, first, the original image data acquisition part 301 acquires the original image data 7 (Step S1).

Subsequently, before the real printing, the provisional printing is performed (Step S2). Specifically, the shading compensation part 302 performs the shading compensation o the original image data 7 acquired in Step S1, and on the basis of the corrected image data 8 which is obtained thus, the print control part 303 performs the printing operation, to thereby generate the provisional printed matter 2.

Next, the correction of the LUT 9 is performed (Step S3). Specifically, first, the target head specifying part 304 specifies the head 511 (target head 511) whose ejection performance has been changed since the last correction (Step S31). Then, the LUT correction part 305 corrects the content of the LUT 9 (target LUT 9) corresponding to the target head 511 to one reflecting the ejection performance of the target head 511 at the present time (Step S32). More detailed discussion will be made later on the operation flow of Steps S31 and S32.

When the correction of the LUT 9 is completed, the real printing is performed (Step S4). Specifically, the shading compensation part 302 performs the shading compensation using the corrected LUT 9 on the original image data 7 acquired in Step S1. Then, halftone screening is performed on the corrected image data 8 which is obtained thus, to thereby generate a print image, and the print control part 303 performs the printing operation on the basis of the generated print image, to thereby generate a real printed matter.

Thus, by performing the shading compensation using the LUT 9 corrected by the LUT correction part 305 (i.e., the LUT 9 corrected so that the content thereof may be in agreement with the ejection performance of each of the heads 511 at the point in time when the printing operation is performed), the density of the printing area of which the target head 511 is in charge is adjusted and occurrence of the head level difference is suppressed. In other words, the LUT correction part 305 and the shading compensation part 302 cooperate to serve as the density correction part 306 for correcting the print density of the printing area of which the target head 511 specified by the target head specifying part 304 is in charge (see FIG. 6).

<4-2. Operation Flow for Specifying Target Head 511>

With reference to FIG. 21, discussion will be made on a flow of the operation for specifying the target head 511 (Step S31 in FIG. 20). FIG. 21 is a flowchart showing the operation flow.

First, the provisional print read data acquisition part 341 acquires the provisional printed matter picked-up image data 10 (Step S11). Specifically, the provisional print read data acquisition part 341 causes the image pickup part 6 to read the provisional printed matter 2 generated in Step S2 and acquires the read data which is obtained thus, as the provisional print read data 10.

Subsequently, the provisional print read data display control part 342 displays the provisional printed matter picked-up image data 10 acquired in Step S11 on the display part 32 (Step S12). The provisional print read data display screen 300 illustrated in FIG. 13 is thereby displayed on the display part 32.

When the selection of the position in the provisional printed matter 2 is received from the user through the provisional print read data display screen 300 displayed in Step S12 (“YES” in Step S13), the selected position corresponding head specifying part 343 specifies the four heads 511 which performed printing on the selected position which is received (Step S14).

Subsequently, the correction target head narrowing-down part 344 displays the unit selection button group 360 on the provisional print read data display screen 300 (FIG. 14) (Step S15).

When the selection of one head unit 51 to be corrected is received from the user (“YES” in Step S16), the correction target head narrowing-down part 344 specifies one of the four heads 511 specified in Step S13, which is included in the head unit 51 selected in Step S16, as the target head 511 to be corrected (Step S17).

<4-3. Operation Flow for Correcting Target LUT 9>

With reference to FIG. 22, discussion will be made on a flow of the operation for correcting the LUT 9 (target LUT 9) corresponding to the target head 511 (Step S32 in FIG. 20). FIG. 22 is a flowchart showing the operation flow.

First, the correction direction determination part 351 displays the correction direction selection button group 370 on the provisional print read data display screen 300 (FIG. 15) (Step S21).

When the selection of the direction in which the target LUT 9 is to be corrected is received from the user (“YES” in Step S22), the correction direction determination part 351 stores the selected direction as the correction direction (Step S23).

Subsequently, the candidate LUT generation part 352 generates a plurality of candidate LUTs 91 which are to become correction candidates for the target LUT 9 (Step S24).

Next, the candidate printed matter generation part 353 generates a plurality of candidate printed matters (Step S25). Specifically, the candidate printed matter generation part 353 causes the shading compensation part 302 to perform the shading compensation processes using the plurality of candidate LUTs 91 generated in Step S24 and causes the print control part 303 to perform the printing operations on the basis of the pieces of corrected image data 8 obtained through the shading compensation processes. The plurality of printed matters are thereby generated.

Subsequently, the LUT selection receiving part 354 displays the point selection button group 380 on the provisional print read data display screen 300 (FIG. 19) (Step S26).

When the selection of the candidate LUT 91 to be rewritten as a replacement for the target LUT 9 is received from the user (“YES” in Step S27), the LUT selection receiving part 354 specifies the candidate LUT 91 which is selected, as the selected candidate LUT 92 (Step S28).

Subsequently, the LUT rewrite part 355 rewrites the content of the target LUT 9 with the content of the selected candidate LUT 92 (Step S29).

<5. Effects>

In the above-discussed preferred embodiment, the target head specifying part 304 specifies the head 511 which performed printing on the position selected by the user through the provisional print read data display screen 300 in which the provisional print read data 10 is displayed on display part 32 and determines the specified head 511 as an ejection head (target head 511) to be corrected. In other words, when the user selects a problematic position (for example, a position having a head level difference) in the provisional printed matter through the provisional print read data display screen 300, the head 511 which performed printing on the problematic position is immediately specified as the target head 511. Accordingly, if there is a head which needs to be corrected, such as a head whose ejection performance is changed, it is possible to easily and appropriately specify the head immediately before the real printing is actually performed. Therefore, it is possible to always achieve excellent print quality even in any use environment.

Particularly in the above-discussed preferred embodiment, the density correction part 306 corrects the density of the printing area of which the target head 511 is in charge. Therefore, it is possible to easily and reliably resolve the head level difference.

Further, in the above-discussed preferred embodiment, since the display part 32 is a touch panel, it is possible for the user to easily and accurately select the position.

Furthermore, in the above-discussed preferred embodiment, since the split lines 313 are displayed in the provisional printed matter display area 310 on the provisional print read data display screen 300, when there is a head level difference in the provisional printed matter, the user can prevent himself from missing the head level difference.

<6. Variations>

Though the preferred embodiment of the present invention has been discussed above, the present invention is not limited to the above-discussed preferred embodiment, but allows various variations.

<6-1. Correction of LUTs 9>

In the process of correcting the LUT 9 (Step S3 in FIG. 20) in the above-discussed preferred embodiment, for example, a plurality of LUTs 9 can be corrected at the same time. With reference to FIG. 23, discussion will be made on an operation flow in this case. FIG. 23 is a flowchart showing the operation flow.

First, the target head specifying part 304 specifies one target head 511 (Step S101). This operation is the same as discussed above.

Subsequently, the LUT correction part 305 specifies the correction direction of the target LUT 9 corresponding to the target head 511 specified in Step S101 and generates a plurality of candidate LUTs 91 which are to become correction candidates for the target LUT 9 (Step S102). This operation is the same as that of Steps S21 to S24.

In a case where another head 511 is further specified as the target head 511, subsequently, the operation of Steps S101 and S102 is performed again. By repeating the operation of Steps S101 and S102 a given number of times, it is possible to select a given number of heads 511 as the target heads 511.

When all the heads 511 to be specified as the target heads 511 are selected and the candidate LUTs 91 are generated for all the selected target heads 511 (“YES” in Step S103), the candidate printed matter generation part 353 generates the candidate printed matters (Step S104.). In this case, however, the plurality of candidate LUTs 91 are generated for each of one or more target LUTs 9. Therefore, in the operation of Step S34, the candidate printed matter generation part 353 generates all the combinations of the plurality of candidate LUTs 91 generated for each of the target LUTs 9. Then, the candidate printed matter generation part 353 causes the shading compensation part 302 to perform the shading compensation processes using the generated one or more combinations, respectively. The candidate printed matter generation part 353 further causes the print control part 303 to perform the printing operations on the basis of the plurality of obtained corrected image data 8, respectively. A plurality of candidate printed matters are thereby generated.

When two heads 511 are selected as the target heads 511, for example, since five candidate LUTs 91 are generated for the target LUT 9 corresponding to each of the target heads 511, the number of combinations of the candidate LUTs 91 is twenty five. Therefore, in this case, twenty-five candidate printed matters are generated.

Instead of generating all the combinations, for example, only the combinations of the candidate LUTs 91 for the same point may be generated, to thereby generate the candidate printed matters on the basis of the combinations, respectively.

Subsequently, the LUT selection receiving part 354 receives the selection from the user and specifies the selected candidate LUT 92 to be rewritten as a replacement for each of the one or more target LUTs 9 (Step S105). Specifically, the LUT selection receiving part 354 causes the user to select one of the combinations of the plurality of candidate LUTs 91 generated for each target LUT 9 and specifies the candidate LUTs 91 constituting the selected combination as the selected candidate LUTs 92.

Instead of causing the user to select one of the combinations, the LUT selection receiving part 354 may cause the user to select one of the plurality of candidate LUTs 91 for each target LUT 9.

Subsequently, the LUT rewrite part 355 rewrites the content of each of the one or more target LUTs 9 with the content of the corresponding selected candidate LUT 92 (Step S106).

<6-2. Other Variations>

Though the split lines 311 are displayed in the provisional printed matter display area 310 in the above-discussed preferred embodiment, the split lines 311 do not necessarily have to be displayed. When the split lines 311 are displayed, however, the user can advantageously prevent himself from missing a portion having the head level difference.

Though the LUT 9 used for the shading compensation is stored in the storage part 34 in the above-discussed preferred embodiment, a coefficient value defining a conversion rate may be stored, instead of the LUT 9. In this case, by developing a function with the stored coefficient value, the LUT 9 can be obtained. Further, the shading compensation may be performed by using a cubic function, instead of the LUT 9.

In the above-discussed preferred embodiment, the selected position corresponding head specifying part 343 defines the plurality of divided areas 314 in the provisional print read data display screen 300. As the size of the provisional printed matter 2 in the width direction becomes larger, the number of heads 511 to be used for the printing increases. Since the size of the provisional printed matter display area 310 is limited, the width of the divided area 314 becomes smaller as the number of heads 511 to be used for the printing increases. For such a case, a function to enlargedly display a specified area in the provisional printed matter display area 310 may be further provided.

Though the correction of density for the target head 511 is performed by the density correction part 306 in the above-discussed preferred embodiment, the density correction may be performed in different manners. Further, without providing the function part to perform correction, there may be a case where the target head specifying part 304 only notifies the user of the head 511 which needs to be corrected, which is specified by the target head specifying part 304 (for example, by displaying the head No. on the display part 32).

Though the printing apparatus 1 causes the transfer part 47 for transferring the printing medium 2 in the scan direction to move the printing medium 2 at constant speed relatively to the ejection part in the scan direction crossing the arrangement direction of the plurality of outlets in the above-discussed preferred embodiment, a scan mechanism for moving the printing medium 2 relatively to the ejection part 5 in the scan direction may be constituted in various manner. For example, a mechanism for moving the ejection part in the scan direction may be provided. Further, like in a printing apparatus 1a (sheet-fed printing apparatus) shown in FIG. 24, a stage 201 for holding a rectangular printing medium 2 and a stage moving mechanism 202 for moving the stage 201 in the scan direction (Y direction in FIG. 24) may be provided. In the printing apparatus la of FIG. 24, a position of the stage 201 with respect to a base 200 can be detected by a position detecting module 203 provided on the base 200.

Further, the printing medium 2 in the printing apparatus 1 may be a sheet base as discussed earlier or may be a plate-like member formed of plastic, printing paper, or the like.

While the invention has been shown and described in detail, the foregoing description is in all aspects illustrative and not restrictive. It is therefore understood that numerous modifications and variations can be devised without departing from the scope of the invention.

### DESCRIPTION OF REFERENCE NUMERALS

1 printing apparatus

3 control device

4 transfer part

5 ejection part

6 image pickup part

51 head unit

300 provisional print read data display screen

301 original image data acquisition part

302 shading compensation part

303 print control part

304 target head specifying part

305 LUT correction part

511 head

1. A printing apparatus which is an inkjet printing apparatus for performing printing by ejecting ink droplets from outlets of ejection heads toward a printing medium, comprising:
a plurality of said ejection heads arranged across an entire width direction of said printing medium, said width direction being a direction crossing a printing direction;
a transfer part for relatively moving said printing medium and said plurality of ejection heads in said printing direction;
a print control part for causing said ejection heads to eject ink droplets therefrom on the basis of print data while controlling said transfer part to relatively move said printing medium and said plurality of ejection heads in said printing direction;
an image pickup part for picking up an image of a printed matter which is said printing medium after printing; and
a target ejection head specifying part for specifying a target ejection head to be corrected among said plurality of ejection heads,
wherein said target ejection head specifying part comprises:
a display control part for displaying picked-up image data of said printed matter acquired by said image pickup part on a display part; and
a selected position corresponding head specifying part for receiving selection of a position in said printed matter from a user through a display screen displaying said picked-up image data, specifying an ejection head which performs printing on a selected position which is said received position in said printed matter, and determining said ejection head as said target ejection head, said selected position corresponding head specifying part displays split lines at positions in said display screen which correspond to boundaries between printing areas of which said plurality of ejection heads are in charge, respectively, in said printed matter which is displayed on said display screen.

2. The printing apparatus according to claim 1, further comprising:
a density correction part for correcting the density of a printing area of which said target ejection head is in charge.

3. The printing apparatus according to claim 2, wherein said density correction part comprises:
a tone correction part for dividing said print data into partial areas corresponding to printing areas of which said plurality of ejection heads are in charge, respectively, and correcting tone values of pixels in each of said partial areas by using a coefficient which is individually set for the partial area; and
a coefficient correction part for correcting a value of said coefficient which is set for a partial area corresponding to a printing area of which said target ejection head is in charge.

4. The printing apparatus according to claim 1, wherein
said display part is a touch panel, and
said selected position corresponding head specifying part receives a position in said display screen which said user touches, as said selected position.

5. (canceled)

6. A method of correcting density in an inkjet printing apparatus which performs printing by ejecting ink droplets from outlets of ejection heads toward a printing medium, comprising the steps of:
a) performing provisional printing on the basis of print data by ejecting ink droplets from a plurality of said ejection heads on the basis of said print data while relatively moving said printing medium and said plurality of ejection heads arranged across an entire width direction of said printing medium in a printing direction, said width direction being a direction crossing said printing direction;
b) picking up an image of a provisional printed matter which is generated in said step a);
c) displaying picked-up image data of said provisional printed matter on a display part;
d) displaying split lines at positions in said display screen which correspond to boundaries between printing areas of which said plurality of ejection heads are in charge, respectively, in said printed matter which is displayed on said display screen;
e) receiving selection of a position in said provisional printed matter from a user through a display screen displaying said picked-up image data;
f) specifying an ejection head which performs printing on a selected position which is said position in said provisional printed matter, which is received in said step e); and
g) correcting the density of a printing area of which a target ejection head is in charge, said target ejection head being said ejection head specified in said step f).
